(19) United States
(12) Patent Application Publication
(10) Pub. No.: US 2016/0180776 A1
(43) Pub. Date: Jun. 23, 2016

(54) DISPLAY DEVICE

(71) Applicant: SAMSUNG DISPLAY CO., LTD., Yongin-City (KR)

(72) Inventors: Sang-Jun CHO, Seongnam-si (KR); Jong-Hwa KIM, Seongnam-si (KR)

(21) Appl. No.: 14/800,830

(22) Filed: Jul. 16, 2015

(30) Foreign Application Priority Data
Dec. 18, 2014 (KR) 10-2014-0183476

(51) Int. Cl. G09G 3/32; G09G 3/36

(52) U.S. Cl. CPC G09G 3/3291; G09G 3/3677; G09G 3/3266; G09G 3/3688; G09G 2310/0248; G09G 2330/021; G09G 2310/027; G09G 2310/08

(57) ABSTRACT

A display device includes a display panel, a scan driver, a data driver, and a timing controller. The display panel includes charge-sharing control switches connected to scan lines and data lines, and each of the charge-sharing control switches is connected between adjacent data lines. The scan driver provides sequentially activated scan signals via the scan lines. The data driver provides data voltages generated by performing a digital-to-analog conversion on data signals provided via the data lines. The data driver controls the charge-sharing control switches based on one or more predetermined bits of adjacent data signals corresponding to adjacent data voltages to be applied to the adjacent data lines. The data driver controls the charge-sharing control switches in a charge-sharing period. The timing controller controls the scan driver and the data driver and provides the data signals to the data driver.

### CROSS-REFERENCE TO RELATED APPLICATION

Korean Patent Application No. 10-2014-0183476, filed on Dec. 18, 2014, and entitled, “Display Devices,” is incorporated by reference herein in its entirety.

### BACKGROUND

1. Field

One or more embodiments described herein relate to a display device.

2. Description of the Related Art

Display devices are being developed with greater size and speed in order to meet consumer demand. As size and speed increase, data lines may be insufficiently charged and discharged. In an attempt to prevent this from happening, a charge-sharing operation has been proposed for the data lines.

The charge-sharing operation is performed by connecting all data lines in the display device, i.e., all output channels of a data driver. As a result, power consumption increases in data lines carrying data voltages that do not change, even though power consumption decreases in data lines carrying data voltages which do change.

The charge-sharing operation may also cause a number of other inconsistencies. For example, the data voltages are generated by converting digital signals from a timing controller to analog signals, and a charge-sharing control switch is located in the data driver. Consequently, the charge-sharing effect may be degraded by resistive elements (e.g., electrostatic discharge (ESD)) resistance, bonding resistance, and wiring resistance in the data lines that occur when charge-sharing is performed.

### SUMMARY

In accordance with one or more embodiments, a display device includes a display panel including pixels and charge-sharing control switches, the pixels connected to scan lines and data lines and each of the charge-sharing control switches connected between adjacent data lines; a scan driver to provide sequentially activated scan signals via the scan lines; a data driver to provide data voltages generated by performing a digital-to-analog conversion on data signals provided via the data lines and to control the charge-sharing control switches based on one or more predetermined bits of adjacent data signals corresponding to adjacent data voltages to be applied to the adjacent data lines, the data driver to control the charge-sharing control switches in a charge-sharing period; and a timing controller to control the scan driver and the data driver and to provide the data signals to the data driver.

The data voltages may be grayscale representation voltages for the pixels, the data signals may be digital signals indicating grayscale values for the pixels, and the display device may be driven by an analog driving technique. The data driver may include a plurality of charge-sharing control blocks, and each of the charge-sharing control blocks may be connected between the adjacent data lines and may generate a charge-sharing control signal based on the one or more predetermined bits of the adjacent data signals, and the charge-sharing control signal may determine whether to turn on or turn off a corresponding one of the charge-sharing control switches.

The charge-sharing control signal may have a first voltage level for turning on the corresponding one of the charge-sharing control switches or a second voltage level for turning off the corresponding one of the charge-sharing control switches when a charge-sharing enable signal is activated, and the charge-sharing control signal may only have the second voltage level for turning off the corresponding one of the charge-sharing control switches when the charge-sharing enable signal is deactivated.

The adjacent data lines may include a first adjacent data line and a second adjacent data line, the adjacent data signals may include a first adjacent data signal applied to the first adjacent data line and a second adjacent data signal applied to the second adjacent data line, and the corresponding one of the charge-sharing control switches may include a transistor having a first electrode connected to the first adjacent data line, a second electrode connected to the second adjacent data line, and a gate electrode that receives the charge-sharing control signal.

Each of the charge-sharing control blocks may include a first edge detection block to generate a first detection signal indicating whether the one or more predetermined bits of the first adjacent data signal is changed; a second edge detection block to generate a second detection signal indicating whether the one or more predetermined bits of the second adjacent data signal is changed; an edge comparison block to output a comparison result signal indicating whether the one or more predetermined bits of the first and second adjacent data signals have different logic levels based on the first detection signal and the second detection signal; and a signal generation block to generate the charge-sharing control signal based on the comparison result signal.

Charge-sharing may be performed between the first and second adjacent data lines as the first adjacent data line is electrically connected to the second adjacent data line, when the corresponding one of the charge-sharing control switches is turned on based on the charge-sharing control signal in the charge-sharing period.

Each of the charge-sharing control blocks may turn-on the corresponding one of the charge-sharing control switches in the charge-sharing period when: the one or more predetermined bits of the first adjacent data signal is changed, the one or more predetermined bits of the second adjacent data signal is changed, and the one or more predetermined bits of the first and second adjacent data signals have different logic levels.

Charge-sharing may not be performed between the first and second adjacent data lines as the first adjacent data line is electrically separated from the second adjacent data line when the corresponding one of the charge-sharing control switches is turned off based on the charge-sharing control signal in the charge-sharing period.

Each of the charge-sharing control blocks may turn-off the corresponding one of the charge-sharing control switches in the charge-sharing period when: the one or more predetermined bits of the first adjacent data signal is not changed, the one or more predetermined bits of the second adjacent data signal is not changed, or the one or more predetermined bits of the first and second adjacent data signals have same logic levels. The one or more predetermined bits may include a most significant bit.

In accordance with one or more other embodiments, a display device includes a display panel including pixels and charge-sharing control switches, the pixels connected to scan lines and data lines and each of the charge-sharing control switches connected between adjacent data lines; a scan driver to provide sequentially activated scan signals via the scan lines; a data driver to provide data voltages generated by performing a digital-to-analog conversion on data signals provided via the data lines and to control the charge-sharing control switches based on logic levels of adjacent data signals corresponding to adjacent data voltages to be applied to the adjacent data lines, the data driver to control the charge-sharing control switches in a charge-sharing period; and a timing controller to control the scan driver and the data driver and to provide the data signals to the data driver.

The data voltages may be driving transistor control voltages for the pixels, the data signals may be digital signals indicating a logic high level or a logic low level, and the display device may be driven by a digital driving technique.

The data driver may include a plurality of charge-sharing control blocks, and each of the charge-sharing blocks may be connected between the adjacent data lines and may generate a charge-sharing control signal based on the logic levels of the adjacent data signals, the charge-sharing control signal indicating whether to turn on or turn off a corresponding one of the charge-sharing control switches.

The charge-sharing control signal may have a first voltage level for turning on the corresponding one of the charge-sharing control switches or a second voltage level for turning off the corresponding one of the charge-sharing control switches when a charge-sharing enable signal is activated, and the charge-sharing control signal may only have the second voltage level for turning off the corresponding one of the charge-sharing control switches when the charge-sharing enable signal is deactivated.

The adjacent data lines may include a first adjacent data line and a second adjacent data line, the adjacent data signals may include a first adjacent data signal applied to the first adjacent data line and a second adjacent data signal applied to the second adjacent data line, and the corresponding one of the charge-sharing control switches may include a transistor having a first electrode connected to the first adjacent data line, a second electrode connected to the second adjacent data line, and a gate electrode to receive the charge-sharing control signal.

Each of the charge-sharing control blocks may include a first edge detection block to generate a first detection signal indicating whether the logic level of the first adjacent data signal is changed; a second edge detection block to generate a second detection signal indicating whether the logic level of the second adjacent data signal is changed; an edge comparison block to output a comparison result signal indicating whether the logic levels of the first and second adjacent data signals are different based on the first detection signal and the second detection signal; and a signal generation block to generate the charge-sharing control signal based on the comparison result signal.

Charge-sharing may be performed between the first adjacent data line and the second adjacent data line as the first adjacent data line is electrically connected to the second adjacent data line when the corresponding one of the charge-sharing control switches is turned on based on the charge-sharing control signal in the charge-sharing period.

Each of the charge-sharing control blocks may turn-on the corresponding one of the charge-sharing control switches in the charge-sharing period when the logic level of the first adjacent data signal is changed, the logic level of the second adjacent data signal is changed, and the logic levels of the first and second adjacent data signals are different.

Charge-sharing may not be performed between the first adjacent data line and the second adjacent data line as the first adjacent data line is electrically separated from the second adjacent data line, when the corresponding one of the charge-sharing control switches is turned off based on the charge-sharing control signal in the charge-sharing period.

Each of the charge-sharing control blocks may turn-off the corresponding one of the charge-sharing control switches in the charge-sharing period when: the logic level of the first adjacent data signal is not changed, the logic level of the second adjacent data signal is not changed, or the logic levels of the first and second adjacent data signals are equal.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates an embodiment of charge-sharing control switches;

FIG. 3 illustrates an embodiment of charge-sharing control blocks for an analog driving technique;

FIG. 4 illustrates an embodiment of charge-sharing control blocks for a digital driving technique;

FIG. 5 illustrates an embodiment of a charge-sharing control block in a data driver;

FIG. 6 illustrates an embodiment of a rising edge detector;

FIG. 7 illustrates an embodiment of control signals for the rising edge detector;

FIG. 8 illustrates an embodiment of a falling edge detector;

FIG. 9 illustrates an embodiment of control signals for the falling edge detector;

FIG. 10 illustrates an embodiment of an edge comparator;

FIG. 11 illustrates an embodiment of control signals for the edge comparator;

FIG. 12 illustrates an embodiment of a charge-sharing method;

FIG. 13 illustrates another embodiment of a charge-sharing method;

FIG. 14 illustrates an embodiment of an electronic device;

FIG. 15 illustrates an embodiment of a television;

FIG. 16 illustrates an embodiment of a smart phone.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. One or more of the embodiments may be combined to form additional embodiments. Like reference numerals refer to like elements throughout.

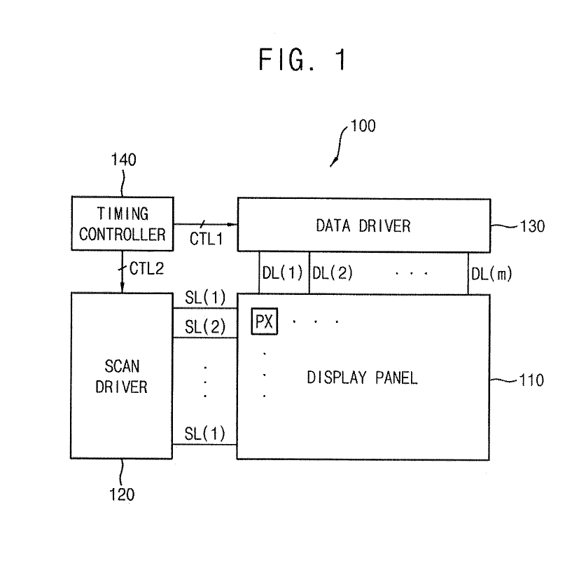

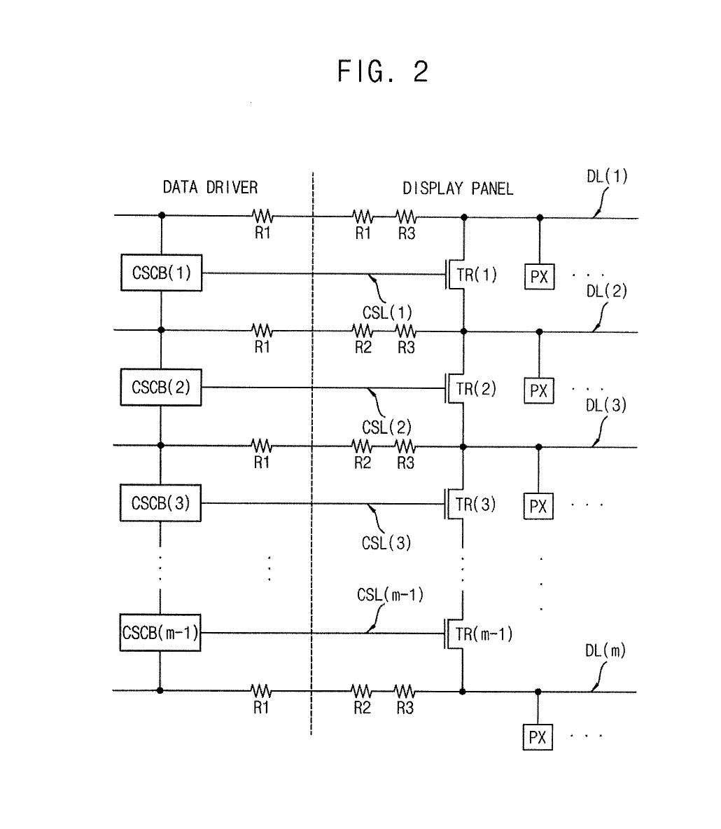

FIG. 1 illustrates an embodiment of display device 100, and FIG. 2 illustrates an embodiment of charge-sharing control switches in the display device of FIG. 1. Referring to FIGS. 1 and 2, the display device 100 includes a display panel 110, a scan driver 120, a data driver 130, and a timing controller 140.

In an example embodiment, the display device 100 may be a liquid crystal display device. In this case, the display device 100 may further include a backlight unit that provides light to the display panel 110. In another example embodiment, the display device 100 may be an organic light emitting display device. In this case, the display device 100 may further include a power supply unit that provides a high power voltage ELVDD and a low power voltage ELVSS to the display panel 110. The display device 100 may be a different type of device in another embodiment.

The display panel 110 includes pixels PX connected to scan lines SL(1) through SL(n) and data lines DL(1) through DL(m). The pixels PX are arranged at locations corresponding to intersections of the scan lines SL(1) through SL(n) and the data lines DL(1) through DL(m) in the display panel 110. The display panel 110 may include, for example, n*m pixels PX.

In addition, as illustrated in FIG. 2, the display panel 110 may include charge-sharing control switches TR(1) through TR(m−1) connected between the data lines DL(1) through DL(m). For example, each of the charge-sharing control switches TR(1) through TR(m−1) may be connected between two adjacent data lines DL(1) through DL(m) in the display panel 110. For example, the charge-sharing control switch TR(1) may be connected between the data line DL(1) and the data line DL(2), the charge-sharing control switch TR(2) may be connected between the data line DL(2) and the data line DL(3). The charge-sharing control switch TR(m−1) may be connected between the data line DL(m−1) and the data line DL(m).

Thus, the number of the charge-sharing control switches TR(1) through TR(m−1) may be less than the number of the data lines DL(1) through DL(m) by 1. In some example embodiments, each of the charge-sharing control switches TR(1) through TR(m−1) may be implemented by a transistor, which includes first and second electrodes (e.g., a source electrode and a drain electrode) connected to adjacent data lines DL(1) through DL(m) and a gate electrode that receives a charge-sharing control signal. For example, the transistor may be an n-channel metal-oxide semiconductor (NMOS) transistor, a p-channel metal-oxide semiconductor (PMOS) transistor, or a complementary metal-oxide semiconductor (CMOS) transistor.

The scan driver 120 provides scan signals to the display panel 110 via the scan lines SL(1) through SL(n). The data driver 130 provides data voltages to the display panel 110 via the data lines DL(1) through DL(m). The data voltages are generated by performing a digital-analog conversion on data signals. The timing controller 140 controls the scan driver 120 and the data driver 130, for example, based on control signals CTL1 and CTL2. The data signals may be input to the data driver 130 via the timing controller 140. In one example embodiment, a data signal compensator in the timing controller 140 or a data signal compensator connected to the timing controller 140 may perform gamma compensation, degradation (or, deterioration) compensation, and/or luminance compensation on the data signals.

In an example embodiment, the display device 100 may be driven by an analog driving technique. In this case, the data voltages are generated by performing a digital-to-analog conversion on data signals. The data signals may be digital signals indicating grayscale values to be represented by the pixels PX in the display panel 110. For example, each data signal may include a plurality of bits indicating the grayscale values to be represented by the pixels PX. Thus, the data driver 130 may control the charge-sharing control switches TR(1) through TR(m−1), in a charge-sharing period, based on predetermined (e.g., most significant) bits of adjacent data signals (e.g., adjacent digital signals before the digital-analog conversion is performed) corresponding to adjacent data voltages to be applied to adjacent data lines DL(1) through DL(m).

For this operation, the data driver 130 may include charge-sharing control blocks CSCB(1) through CSCB(m−1) connected between the adjacent data lines DL(1) through DL(m). The charge-sharing control blocks CSCB(1) through CSCB(m−1) may generate the charge-sharing control signals that determine whether to turn on or turn off the charge-sharing control switches TR(1) through TR(m−1) based on the most significant bits of the adjacent data signals.

For example, as illustrated in FIG. 2, the data driver 130 includes the charge-sharing control blocks CSCB(1) through CSCB(m−1) connected between output channels, e.g., the data lines DL(1) through DL(m). For example, the charge-sharing control block CSCB(1) may be connected between the data line DL(1) and the data line DL(2). The charge-sharing control block CSCB(2) may be connected between the data line DL(2) and the data line DL(3). The charge-sharing control block CSCB(m−1) may be connected between the data line DL(m−1) and the data line DL(m). Thus, the number of the charge-sharing control blocks CSCB(1) through CSCB(m−1) may be less than the number of data lines DL(1) through DL(m) by 1.

As illustrated in FIG. 2, the charge-sharing control blocks CSCB(1) through CSCB(m−1) of the data driver 130 may be connected to the charge-sharing control switches TR(1) through TR(m−1) of the display panel 110, respectively. The charge-sharing control blocks CSCB(1) through CSCB(m−1) of the data driver 130 may output the charge-sharing control signals to the charge-sharing control switches TR(1) through TR(m−1) of the display panel 110 via charge-sharing control lines CSL(1) through CSL(m−1), respectively. The charge-sharing control signals output from the charge-sharing control blocks CSCB(1) through CSCB(m−1) of the data driver 130 may determine whether to turn on or turn off the charge-sharing control switches TR(1) through TR(m−1), respectively.

For example, the charge-sharing control block CSCB(1) may determine whether to turn on or turn off the charge-sharing control switch TR(1), the charge-sharing control block CSCB( )may determine whether to turn on or turn off the charge-sharing control switch TR(2), and the charge-sharing control block CSCB(m−1) may determine whether to turn on or turn off the charge-sharing control switch TR(m−1).

When the charge-sharing control signal has a first voltage level (e.g., a turn on voltage level), the charge-sharing control switch TR(i) to which the charge-sharing control signal is applied (where i is an integer between 1 and m−1) may be turned on. When the charge-sharing control signal has a second voltage level (i.e., a turn off voltage level), the charge-sharing control switch TR(i) to which the charge-sharing control signal is applied may be turned off.

As described above, since the charge-sharing control switches TR(1) through TR(m−1) of the display panel 110 are turned on or turned off independently according to the charge-sharing control signals output from the charge-sharing control blocks CSCB(1) through CSCB(m−1) of the data driver 130, the display device 100 may independently perform the charge-sharing only between the data lines DL(1) through DL(m) that require the charge-sharing. For example, the display device 100 may perform the charge-sharing between the data lines DL(1) through DL(m) that require charge-sharing, but may not perform the charge-sharing between the data lines DL(1) through DL(m) that do not require charge-sharing. In one example embodiment, the display device 100 performs charge-sharing only in the charge-sharing period.

As described above, when a charge-sharing control switch TR(i) is turned on based on the charge-sharing control signal applied to the charge-sharing control switch TR(i) in the charge-sharing period, adjacent data lines DL(i) through DL(i+1) between which the charge-sharing control switch TR(i) is located may be electrically connected to each other. As a result, the adjacent data lines DL(i) through DL(i+1) may perform charge-sharing.

On the other hand, when the charge-sharing control switch TR(i) is turned off based on the charge-sharing control signal applied to the charge-sharing control switch TR(i) in the charge-sharing period, the adjacent data lines DL(i) through DL(i+1) between which the charge-sharing control switch TR(i) is located may be electrically separated from each other. As a result, the adjacent data lines DL(i) through DL(i+1) may not perform charge-sharing.

The charge-sharing period in which the charge-sharing is performed may be just before or after a pixel operation period in which the data voltages are applied to the data lines DL(1) through DL(m) for each scan line SL(1) through SL(n). Therefore, a charge-sharing enable signal may be activated in the charge-sharing period, but may be deactivated in the pixel operation period. As a result, when the charge-sharing enable signal is activated (e.g., in the charge-sharing period), the charge-sharing control signal may have the first voltage level for turning on the charge-sharing control switches TR(1) through TR(m−1) or the second voltage level for turning off the charge-sharing control switches TR(1) through TR(m−1).

For example, the charge-sharing may be independently performed only between the data lines DL(1) through DL(m) that require the charge-sharing in the charge-sharing period. On the other hand, when the charge-sharing enable signal is deactivated (e.g., in the pixel operation period), the charge-sharing control signal may have only the second voltage level for turning off the charge-sharing control switches TR(1) through TR(m−1). For example, the charge-sharing may not be performed between the data lines DL(1) through DL(m) in the pixel operation period.

In one embodiment, the charge-sharing control blocks CSCB(1) through CSCB(m−1) may turn on the charge-sharing control switches TR(1) through TR(m−1) in the charge-sharing period when the most significant bits of the adjacent data signals. corresponding to the adjacent data voltages to be applied to the adjacent data lines DL(1) through DL(m), are changed (e.g., a most significant bit of a first adjacent data signal corresponding to a first adjacent data voltage to be applied to a first adjacent data line is changed and a most significant bit of a second adjacent data signal corresponding to a second adjacent data voltage to be applied to a second adjacent data line is also changed) and the most significant bits of the adjacent data signals corresponding to the adjacent data voltages to be applied to the adjacent data lines DL(1) through DL(m) have different (e.g., opposite) logic levels. Thus, since the adjacent data lines DL(1) through DL(m) are electrically connected to each other in the charge-sharing period, the charge-sharing may be performed between the adjacent data lines DL(1) through DL(m).

On the other hand, the charge-sharing control blocks CSCB(1) through CSCB(m−1) may turn off the charge-sharing control switches TR(1) through TR(m−1) in the charge-sharing period when at least one of the most significant bits of the adjacent data signals corresponding to the adjacent data voltages to be applied to the adjacent data lines DL(1) through DL(m) is not changed (e.g., the most significant bit of the first adjacent data signal corresponding to the first adjacent data voltage to be applied to the first adjacent data line is not changed and/or the most significant bit of the second adjacent data signal corresponding to the second adjacent data voltage to be applied to the second adjacent data line is not changed) and/or the most significant bits of the adjacent data signals corresponding to the adjacent data voltages to be applied to the adjacent data lines DL(1) through DL(m) have the same logic levels. Thus, since the adjacent data lines DL(1) through DL(m) are electrically separated (or blocked) from each other in the charge-sharing period, the charge-sharing may not be performed between the adjacent data lines DL(1) through DL(m).

As described above, the display device 100 driven by the analog driving technique may determine whether to perform charge-sharing between adjacent data lines DL(1) through DL(m) based on the most significant bits of the adjacent data signals corresponding to the adjacent data voltages to be applied to the adjacent data lines DL(1) through DL(m).

In another example embodiment, the display device 100 may be driven by a digital driving technique. In this case, the data voltages are generated by performing the digital-analog conversion on the data signals and may serve as driving transistor control voltages for the pixels PX in the display panel 110. The data signals may be digital signals indicating a logic ‘high’ level or a logic ‘low’ level (e.g., levels for turning on or turning off the driving transistors of the pixels PX).

For example, each of the data signals may include (or correspond to) a single bit indicating a logic ‘high level or a logic ‘low’ level. Thus, the data driver 130 may control charge-sharing control switches TR(1) through TR(m−1) in the charge-sharing period based on the logic levels of adjacent data signals (e.g., adjacent digital signals before the digital-analog conversion is performed) corresponding to adjacent data voltages to be applied to adjacent data lines DL(1) through DL(m).

For this operation, the data driver 130 may include the charge-sharing control blocks CSCB(1) through CSCB(m−1) connected between the adjacent data lines DL(1) through DL(m). The charge-sharing control blocks CSCB(1) through CSCB(m−1) may generate the charge-sharing control signals that determine whether to turn on or turn off the charge-sharing control switches TR(1) through TR(m−1) based on the logic levels of the adjacent data signals.

For example, as illustrated in FIG. 2, the data driver 130 may include the charge-sharing control blocks CSCB(1) through CSCB(m−1) connected between the output channels (i.e., the data lines DL(1) through DL(m)). For example, the charge-sharing control block CSCB(1) may be connected between the data line DL(1) and the data line DL(2), the charge-sharing control block CSCB(2) may be connected between the data line DL(2) and the data line DL(3), and the charge-sharing control block CSCB(m−1) may be connected between the data line DL(m−1) and the data line DL(m). Thus, the number of charge-sharing control blocks CSCB(1) through CSCB(m−1) may be less than the number of the data lines DL(1) through DL(m) by 1.

As illustrated in FIG. 2, the charge-sharing control blocks CSCB(1) through CSCB(m−1) of the data driver 130 may be connected to the charge-sharing control switches TR(1) through TR(m−1) of the display panel 110, respectively. The charge-sharing control blocks CSCB(1) through CSCB(m−1) of the data driver 130 may output the charge-sharing control signals to the charge-sharing control switches TR(1) through TR(m−1) of the display panel 110 via the charge-sharing control lines CSL(1) through CSL(m−1), respectively.

The charge-sharing control signals output from the charge-sharing control blocks CSCB(1) through CSCB(m−1) of the data driver 130 may determine whether to turn on or turn off the charge-sharing control switches TR(1) through TR(m−1), respectively. For example, the charge-sharing control block CSCB(1) may determine whether to turn on or turn off the charge-sharing control switch TR(1), the charge-sharing control block CSCB(2) may determine whether to turn on or turn off the charge-sharing control switch TR(2), and the charge-sharing control block CSCB(m−1) may determine whether to turn on or turn off the charge-sharing control switch TR(m−1).

When the charge-sharing control signal has a first voltage level (e.g., a turn on voltage level), the charge-sharing control switch TR(i) to which the charge-sharing control signal is applied (where i is an integer between 1 and m−1) may be turned on. On the other hand, when the charge-sharing control signal has a second voltage level (e.g., a turn off voltage level), the charge-sharing control switch TR(i) to which the charge-sharing control signal is applied may be turned off.

As described above, since the charge-sharing control switches TR(1) through TR(m−1) of the display panel 110 are turned on or turned off independently according to the charge-sharing control signals output from the charge-sharing control blocks CSCB(1) through CSCB(m−1) of the data driver 130, the display device 100 may independently perform the charge-sharing only between the data lines DL(1) through DL(m) that require charge-sharing. For example, the display device 100 may perform charge-sharing between the data lines DL(1) through DL(m) that require the charge-sharing, but may not perform charge-sharing between the data lines DL(1) through DL(m) that do not require charge-sharing. In one embodiment, the display device 100 may perform charge-sharing only in the charge-sharing period.

As described above, when a charge-sharing control switch TR(i) is turned on based on the charge-sharing control signal applied to the charge-sharing control switch TR(i) in the charge-sharing period, adjacent data lines DL(i) through DL(i+1) between which the charge-sharing control switch TR(i) is located may be electrically connected to each other. As a result, the adjacent data lines DL(i) through DL(i+1) may perform charge-sharing. On the other hand, when the charge-sharing control switch TR(i) is turned off based on the charge-sharing control signal applied to the charge-sharing control switch TR(i) in the charge-sharing period, the adjacent data lines DL(i) through DL(i+1) between which the charge-sharing control switch TR(i) is located may be electrically separated from each other. As a result, the adjacent data lines DL(i) through DL(i+1) may not perform charge-sharing.

The charge-sharing period in which the charge-sharing is performed may be placed just before or after the pixel operation period in which the data voltages are applied to the data lines DL(1) through DL(m) for each scan line SL(1) through SL(n). Therefore, the charge-sharing enable signal may be activated in the charge-sharing period, but may be deactivated in the pixel operation period. As a result, when the charge-sharing enable signal is activated (e.g., in the charge-sharing period), the charge-sharing control signal may have the first voltage level for turning on the charge-sharing control switches TR(1) through TR(m−1) or the second voltage level for turning off the charge-sharing control switches TR(1) through TR(m−1). For example, charge-sharing may be independently performed only between the data lines DL(1) through DL(m) that require the charge-sharing in the charge-sharing period.

On the other hand, when the charge-sharing enable signal is deactivated (e.g., in the pixel operation period), the charge-sharing control signal may have only the second voltage level for turning off the charge-sharing control switches TR(1) through TR(m−1). For example, charge-sharing may not be performed between the data lines DL(1) through DL(m) in the pixel operation period.

In one embodiment, the charge-sharing control blocks CSCB(1) through CSCB(m−1) may turn on the charge-sharing control switches TR(1) through TR(m−1) in the charge-sharing period when the logic levels of the adjacent data signals corresponding to the adjacent data voltages to be applied to the adjacent data lines DL(1) through DL(m) are changed (e.g., a logic level of a first adjacent data signal corresponding to a first adjacent data voltage to be applied to a first adjacent data line is changed and a logic level of a second adjacent data signal corresponding to a second adjacent data voltage to be applied to a second adjacent data line is also changed) and the logic levels of the adjacent data signals corresponding to the adjacent data voltages to be applied to the adjacent data lines DL(1) through DL(m) are different (e.g., opposite). Thus, since the adjacent data lines DL(1) through DL(m) are electrically connected to each other in the charge-sharing period, charge-sharing may be performed between the adjacent data lines DL(1) through DL(m).

On the other hand, the charge-sharing control blocks CSCB(1) through CSCB(m−1) may turn off the charge-sharing control switches TR(1) through TR(m−1) in the charge-sharing period when at least one of the logic levels of the adjacent data signals corresponding to the adjacent data voltages to be applied to the adjacent data lines DL(1) through DL(m) is not changed (e.g., the logic level of the first adjacent data signal corresponding to the first adjacent data voltage to be applied to the first adjacent data line is not changed and/or the logic level of the second adjacent data signal corresponding to the second adjacent data voltage to be applied to the second adjacent data line is not changed) and/or the logic levels of the adjacent data signals corresponding to the adjacent data voltages to be applied to the adjacent data lines DL(1) through DL(m) are the same. Thus, since the adjacent data lines DL(1) through DL(m) are electrically separated (or blocked) from each other in the charge-sharing period, charge-sharing may not be performed between the adjacent data lines DL(1) through DL(m).

As described above, the display device 100 driven by the digital driving technique may determine whether to perform charge-sharing between the adjacent data lines DL(1) through DL(m) based on logic levels of adjacent data signals corresponding to the adjacent data voltages to be applied to adjacent data lines DL(1) through DL(m).

In one embodiment, the display device 100 may include the charge-sharing control switches TR(1) through TR(m−1) in the display panel 110 and may include the charge-sharing control blocks CSCB(1) through CSCB(m−1) that control the charge-sharing control switches TR(1) through TR(m−1) in the data driver 130.

In an example embodiment, when the display device 100 is driven by the analog driving technique, the display device 100 may determine whether to perform charge-sharing between the adjacent data lines DL(1) through DL(m) based on one or more predetermined (e.g., most significant) bits of the adjacent data signals corresponding to the adjacent data voltages to be applied to the adjacent data lines DL(1) through DL(m).

In another example embodiment, when the display device 100 is driven by the digital driving technique, the display device 100 may determine whether to perform charge-sharing between the adjacent data lines DL(1) through DL(m) based on the logic levels of the adjacent data signals corresponding to the adjacent data voltages to be applied to the adjacent data lines DL(1) through DL(m). As a result, the display device 100 may independently perform the charge-sharing only between the data lines DL(1) through DL(m) that require charge-sharing.

As illustrated in FIG. 2, electrical resistive elements may exist in each of the data lines DL(1) through DL(m). Then electrical resistive elements may include, for example, one or more of ESD resistance R1, bonding resistance R2, or wiring resistance R3. In one type of display device which has been proposed, the data driver 130 includes the charge-sharing control switches TR(1) through TR(m−1). Thus, in such a display, charge-sharing between the data lines DL(1) through DL(m) may be performed in the data driver 130. As a result, the effect of the electrical resistive elements may be significant.

However, in at least one embodiment of the display device 100, the charge-sharing control switches TR(1) through TR(m−1) are located in the display panel 110, and the charge-sharing control blocks CSCB(1) through CSCB(m−1) that control the charge-sharing control switches TR(1) through TR(m−1) are located in the data driver 130. As a result, the charge-sharing between the data lines DL(1) through DL(m) may be performed in the display panel 110. Thus, when charge-sharing is performed between the data lines DL(1) through DL(m), the effect of electrical resistive elements may be reduced. In other words, the display device 100 may reduce or prevent a charge-sharing effect from being degraded by the electrical resistive elements.

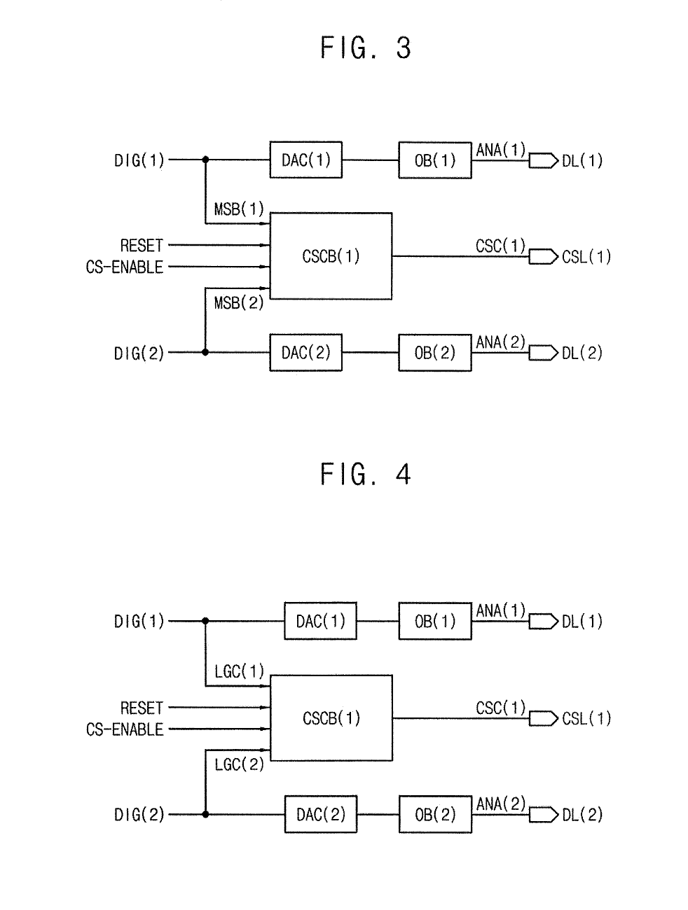

FIG. 3 illustrates an embodiment of charge-sharing control blocks when the display device of FIG. 1 is driven by an analog driving technique. In this embodiment, the data voltages ANA(1) and ANA(2) generated by performing the digital-analog conversion on the data signals DIG(1) and DIG(2) may be grayscale representation voltages for the pixels PX in the display panel 110. The data signals DIG(1) and DIG(2) may be the digital signals indicating grayscale values to be represented by the pixels PX. For convenience of description, only one pair of the adjacent data lines DL(1) and DL(2) (e.g., a first adjacent data line DL(1) and a second adjacent data line DL(2)) is illustrated in FIG. 3. While data lines DL(1) and DL(2) are shown, the embodiment may apply to any other pair of adjacent data lines in the display device.

The digital-analog converters DAC(1) and DAC(2) may perform the digital-analog conversion on the data signals DIG(1) and DIG(2) to generate the data voltages ANA(1) and ANA(2), respectively. The data voltages ANA(1) and ANA(2) may be output to the first and second adjacent data lines DL(1) and DL(2) via output buffers OB(1) and OB(2), respectively. In one example embodiment, the data voltages ANA(1) and ANA(2) may be amplified by the output buffers OB(1) and OB(2), respectively.

Subsequently, when the data voltages ANA(1) and ANA(2) are applied to the pixels PX in the display panel 110, the pixels PX emit light corresponding to the gray scale values corresponding to the data voltages ANA(1) and ANA(2).

Hereinafter, since the data signals DIG(1) and DIG(2) relate to one pair of the adjacent data lines DL(1) and DL(2) (e.g., the first adjacent data line DL(1) and the second adjacent data line DL(2)), the data signal DIG(1) and the data signal DIG(2) will be referred to as a first adjacent data signal DIG(1) and a second adjacent data signal DIG(2). In addition, since the data voltages ANA(1) and ANA(2) relate to one pair of the adjacent data lines DL(1) and DL(2) (e.g., the first adjacent data line DL(1) and the second adjacent data line DL(2)), the data voltage ANA(1) and the data voltage ANA(2) will be referred to as a first adjacent data voltage ANA(1) and a second adjacent data voltage ANA(2).

As described above, the data driver 130 may include the charge-sharing control block CSCB(1) connected between the first adjacent data line DL(1) and the second adjacent data line DL(2). As illustrated in FIG. 3, the charge-sharing control block CSCB(1) may output the charge-sharing control signal CSC(1) to the charge-sharing control switch TR(1) in the display panel 110 via the charge-sharing control line CSL(1). The charge-sharing control signal CSC(1) may determine whether to turn on or turn off the charge-sharing control switch TR(1). For example, when the charge-sharing control signal CSC(1) has a first voltage level (e.g., a turn on voltage level), the charge-sharing control switch TR(1) may be turned on. When the charge-sharing control signal CSC(1) has a second voltage level (e.g., a turn off voltage level), the charge-sharing control switch TR(1) may be turned off.

The charge-sharing control block CSCB(1) may receive one or more predetermined bits (e.g., most significant bit MSB(1)) of the first adjacent data signal DIG(1) from the first adjacent data line DL(1) and one or more predetermined bits (e.g., most significant bit MSB(2)) of the second adjacent data signal DIG(2) from the second adjacent data line DL(2). The charge-sharing control block CSCB(1) may control the charge-sharing control switch TR(1) based on the most significant bit MSB(1) of the first adjacent data signal DIG(1) and the most significant bit MSB(2) of the second adjacent data signal DIG(2) in the charge-sharing period.

For example, the charge-sharing control block CSCB(1) may output the charge-sharing control signal CSC(1) having a first voltage level or the charge-sharing control signal CSC(1) having a second voltage level based on the most significant bit MSB(1) of the first adjacent data signal DIG(1) and the most significant bit MSB(2) of the second adjacent data signal DIG(2) in the charge-sharing period. In one embodiment, the charge-sharing control block CSCB(1) may turn on the charge-sharing control switch TR(1) in the charge-sharing period when the most significant bit MSB(1) of the first adjacent data signal DIG(1) and the most significant bit MSB(2) of the second adjacent data signal DIG(2) are changed and the most significant bit MSB(1) of the first adjacent data signal DIG(1) and the most significant bit MSB(2) of the second adjacent data signal DIG(2) have different logic levels. For example, the charge-sharing control block CSCB(1) may output the charge-sharing control signal CSC(1) having a first voltage level (e.g., a turn on voltage level) via the charge-sharing control line CSL(1) in the charge-sharing period. Thus. since the first adjacent data line DL(1) is electrically connected to the second adjacent data line DL(2), charge-sharing may be performed between the first adjacent data line DL(1) and the second adjacent data line DL(2) in the charge-sharing period.

On the other hand, the charge-sharing control block CSCB(1) may turn off the charge-sharing control switch TR(1) in the charge-sharing period when at least one of a bit (e.g., the most significant bit MSB(1)) of the first adjacent data signal DIG(1) and a bit (e.g., the most significant bit MSB(2)) of the second adjacent data signal DIG(2) is not changed and/or these bits of the first adjacent data signal DIG(1) and the second adjacent data signal DIG(2) have the same logic levels. For example, the charge-sharing control block CSCB(1) may output the charge-sharing control signal CSC(1) having a second voltage level (e.g., a turn off voltage level) via the charge-sharing control line CSL(1) in the charge-sharing period. Thus, since the first adjacent data line DL(1) is electrically separated from the second adjacent data line DL(2), the charge-sharing may not be performed between the first adjacent data line DL(1) and the second adjacent data line DL(2) in the charge-sharing period.

As described above, the charge-sharing control switch TR(1) may be turned on or turned off according to the charge-sharing control signal CSC(1) output from the charge-sharing control block CSCB(1) in the data driver 130. Thus, in the display device 100, charge-sharing may be performed between the data lines DL(1) through DL(m) that require charge-sharing, but charge-sharing may not be performed between the data lines DL(1) through DL(m) that do not require charge-sharing.

The charge-sharing control block CSCB(1) may receive a charge-sharing reset signal RESET and a charge-sharing enable signal CS-ENABLE, for example, from another circuit, e.g., the timing controller 140. The charge-sharing period in which the charge-sharing is performed may be placed just before or after the pixel operation period in which the data voltages are applied to the data lines DL(1) through DL(m) for each scan line SL(1) through SL(n). Thus, the charge-sharing enable signal CS-ENABLE may be activated in the charge-sharing period, and the charge-sharing enable signal CS-ENABLE may be deactivated in the pixel operation period.

As a result, when the charge-sharing enable signal CS-ENABLE is activated (e.g., in the charge-sharing period), the charge-sharing control signal CSC(1) may have a first voltage level for turning on the charge-sharing control switch TR(1) or a second voltage level for turning off the charge-sharing control switch TR(1). In the charge-sharing period, the charge-sharing may be independently performed only between the data lines DL(1) through DL(m) that require the charge-sharing.

On the other hand, when the charge-sharing enable signal CS-ENABLE is deactivated (e.g., the pixel operation period), the charge-sharing control signal CSC(1) may have only a second voltage level for turning off the charge-sharing control switch TR(1). For example, in the pixel operation period, the charge-sharing may not be performed between all data lines DL(1) through DL(m). In addition, the charge-sharing reset signal RESET may reset one or more internal elements (e.g., D-flip-flop, etc.) in the charge-sharing control block CSCB(1) (e.g., may initialize the charge-sharing control block CSCB(1)) at a predetermined time to prepare a next charge-sharing period.

FIG. 4 illustrates an embodiment of charge-sharing control blocks when the display device of FIG. 1 is driven by a digital driving technique. In this embodiment, the data voltages ANA(1) and ANA(2) generated by performing the digital-analog conversion on the data signals DIG(1) and DIG(2) may be the driving transistor control voltages for the pixels PX in the display panel 110. The data signals DIG(1) and DIG(2) may be digital signals indicating a logic ‘high’ level or a logic ‘low’ level (e.g., for turning on or turning off the driving transistors of the pixels PX).

For convenience of description, only one pair of adjacent data lines DL(1) and DL(2) (e.g., first adjacent data line DL(1) and second adjacent data line DL(2)) is in FIG. 4. This description may be applied to other pairs of adjacent data lines.

In one embodiment, the digital-analog converters DAC(1) and DAC(2) may perform the digital-analog conversion on the data signals DIG(1) and DIG(2) to generate the data voltages ANA(1) and ANA(2), respectively. The data voltages ANA(1) and ANA(2) may be output to the first and second adjacent data lines DL(1) and DL(2) via output buffers OB(1) and OB(2), respectively. In one example embodiment, the data voltages ANA(1) and ANA(2) may be amplified by the output buffers OB(1) and OB(2), respectively.

Subsequently, when the data voltages ANA(1) and ANA(2) are applied to the pixels PX in the display panel 110, the data voltages ANA(1) and ANA(2) may turn on or turn off the driving transistors of the pixels PX. Hereinafter, since the data signals DIG(1) and DIG(2) relate to one pair of the adjacent data lines DL(1) and DL(2) (e.g., the first adjacent data line DL(1) and the second adjacent data line DL(2)), the data signal DIG(1) and the data signal DIG(2) will be referred to as a first adjacent data signal DIG(1) and a second adjacent data signal DIG(2).

In addition, since the data voltages ANA(1) and ANA(2) relate to one pair of the adjacent data lines DL(1) and DL(2) (e.g., the first adjacent data line DL(1) and the second adjacent data line DL(2)), the data voltage ANA(1) and the data voltage ANA(2) will be referred to as a first adjacent data voltage ANA(1) and a second adjacent data voltage ANA(2).

As described above, the data driver 130 may include the charge-sharing control block CSCB(1) connected between the first adjacent data line DL(1) and the second adjacent data line DL(2). As illustrated in FIG. 4, the charge-sharing control block CSCB(1) may output the charge-sharing control signal CSC(1) to the charge-sharing control switch TR(1) via the charge-sharing control line CSL(1) The charge-sharing control signal CSC(1) may determine whether to turn on or turn off the charge-sharing control switch TR(1). For example, when the charge-sharing control signal CSC(1) has a first voltage level (e.g., a turn on voltage level), the charge-sharing control switch TR(1) may be turned on. When the charge-sharing control signal CSC(1) has a second voltage level (e.g., a turn off voltage level), the charge-sharing control switch TR(1) may be turned off.

The charge-sharing control block CSCB(1) may receive the logic level LGC(1) of the first adjacent data signal DIG(1) from the first adjacent data line DL(1) and may receive the logic level LGC(2) of the second adjacent data signal DIG(2) from the second adjacent data line DL(2). The charge-sharing control block CSCB(1) may control the charge-sharing control switch TRW based on the logic level LGC(1) of the first adjacent data signal DIG(1) and the logic level LGC(2) of the second adjacent data signal DIG(2) in the charge-sharing period. In other words, the charge-sharing control block CSCB(1) may output the charge-sharing control signal CSC(1) having a first voltage level or the charge-sharing control signal CSC(1) having a second voltage level based on the logic level LGC(1) of the first adjacent data signal DIG(1) and the logic level LGC(2) of the second adjacent data signal DIG(2) in the charge-sharing period.

Although it is described above that the charge-sharing control block CSCB(1) receives the logic level LGC(1) of the first adjacent data signal DIG(1) and the logic level LGC(2) of the second adjacent data signal DIG(2), the first adjacent data signal DIG(1) and the second adjacent data signal DIG(2) may be applied to the charge-sharing control block CSCB(1). This is because the first and second adjacent data signals DIG(1) and DIG(2) correspond to the logic levels LGC(1) and LGC(2), respectively, as a 1-bit signal.

In one embodiment, the charge-sharing control block CSCB(1) may turn on the charge-sharing control switch TR(1) in the charge-sharing period when the logic level LGC(1) of the first adjacent data signal DIG(1) and the logic level LGC(2) of the second adjacent data signal DIG(2) are changed and the logic level LGC(1) of the first adjacent data signal DIG(1) and the logic level LGC(2) of the second adjacent data signal DIG(2) are different. For example, the charge-sharing control block CSCB(1) may output the charge-sharing control signal CSC(1) having a first voltage level (e.g., a turn on voltage level) via the charge-sharing control line CSL(1) in the charge-sharing period. Thus, since the first adjacent data line DL(1) is electrically connected to the second adjacent data line DL(2), the charge-sharing may be performed between the first adjacent data line DL(1) and the second adjacent data line DL(2) in the charge-sharing period.

On the other hand, the charge-sharing control block CSCB(1) may turn off the charge-sharing control switch TR(1) in the charge-sharing period when at least one of the logic level LGC(1) of the first adjacent data signal DIG(1) or the logic level LGC(2) of the second adjacent data signal DIG(2) is not changed and/or the logic level LGC(1) of the first adjacent data signal DIG(1) and the logic level LGC(2) of the second adjacent data signal DIG(2) are the same. For example, the charge-sharing control block CSCB(1) may output the charge-sharing control signal CSC(1) having a second voltage level (e.g., a turn off voltage level) via the charge-sharing control line CSL(1) in the charge-sharing period. Thus, since the first adjacent data line DL(1) is electrically separated from the second adjacent data line DL(2), charge-sharing may not be performed between the first adjacent data line DL(1) and the second adjacent data line DL(2) in the charge-sharing period.

As described above, the charge-sharing control switch TR(1) may be turned on or turned off according to the charge-sharing control signal CSC(1) output from the charge-sharing control block CSCB(1) in the data driver 130. Thus, in the display device 100, charge-sharing may be performed between the data lines DL(1) through DL(m) that require charge-sharing, but charge-sharing may not be performed between the data lines DL(1) through DL(m) that do not require charge-sharing.

The charge-sharing control block CSCB(1) may receive a charge-sharing reset signal RESET and a charge-sharing enable signal CS-ENABLE, for example, from another circuit, e.g., the timing controller 140. The charge-sharing period in which the charge-sharing is performed may be placed just before or after the pixel operation period in which the data voltages are applied to the data lines DL(1) through DL(m) for each scan line SL(1) through SL(n). Thus, the charge-sharing enable signal CS-ENABLE may be activated in the charge-sharing period, and the charge-sharing enable signal CS-ENABLE may be deactivated in the pixel operation period. As a result, when the charge-sharing enable signal CS-ENABLE is activated (e.g., in the charge-sharing period), the charge-sharing control signal CSC(1) may have a first voltage level for turning on the charge-sharing control switch TR(1) or a second voltage level for turning off the charge-sharing control switch TR(1).

In the charge-sharing period, the charge-sharing may be independently performed only between the data lines DL(1) through DL(m) that require charge-sharing. On the other hand, when the charge-sharing enable signal CS-ENABLE is deactivated (e.g., the pixel operation period), the charge-sharing control signal CSC(1) may have only a second voltage level for turning off the charge-sharing control switch TR(1). For example, in the pixel operation period, charge-sharing may not be performed between all data lines DL(1) through DL(m). In addition, the charge-sharing reset signal RESET may reset one or more internal elements in the charge-sharing control block CSCB(1), e.g., may initialize the charge-sharing control block CSCB(1)) at a predetermined time to prepare a next charge-sharing period.

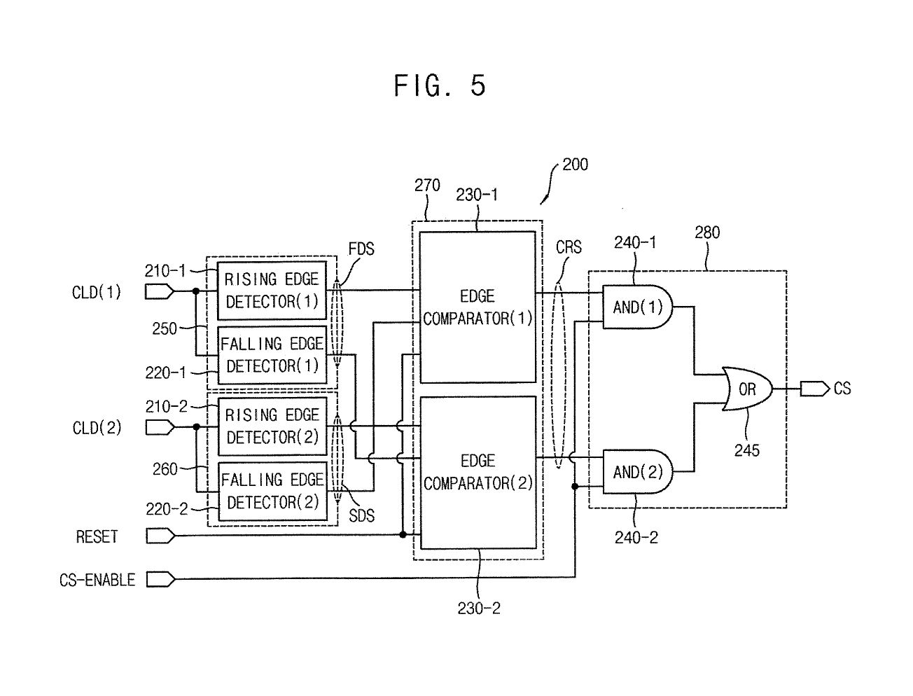

FIG. 5 illustrates another embodiment of a charge-sharing control block in a data driver, which, for example, may be in the display device of FIG. 1. Referring to FIG. 5, the charge-sharing control block 200 includes a first edge detection block 250, a second edge detection block 260, an edge comparison block 270, and a signal generation block 280.

As described above, the charge-sharing control block CSCB(1) of FIG. 3 may receive the most significant bits MSB(1) and MSB(2) of the adjacent data signals DIG(1) and DIG(2) corresponding to the adjacent data voltages ANA(1) and ANA(2). The charge-sharing control block CSCB(1) of FIG. 4 may receive the logic levels LGC(1) and LGC(2) of the adjacent data signals DIG(1) and DIG(2) corresponding to the adjacent data voltages ANA(1) and ANA(2). In FIG. 5, for convenience of description, the most significant bits MSB(1) and MSB(2) of the adjacent data signals DIG(1) and DIG(2) applied to the charge-sharing control block 200 of the display device 100 driven by an analog driving technique, or the logic levels LGC(1) and LGC(2) of the adjacent data signals DIG(1) and DIG(2) applied to the charge-sharing control block 200 of the display device 100 driven by a digital driving technique, are referred to as first and second input signals CLD(1) and CLD(2).

Thus, the first and second input signal CLD(1) and CLD(2) should be interpreted as the most significant bits MSB(1) and MSB(2) of the adjacent data signals DIG(1) and DIG(2) in the display device 100 driven by the analog driving technique and as the logic levels LGC(1) and LGC(2) of the adjacent data signals DIG(1) and DIG(2) in the display device 100 driven by the digital driving technique.

The first edge detection block 250 generates a first detection signal FDS indicating whether the first input signal CLD(1) is changed. For example, in the display device 100 driven by the analog driving technique, the first edge detection block 250 may generate the first detection signal FDS indicating whether the most significant bit MSB(1) of the first adjacent data signal DIG(1) is changed.

In addition, in the display device 100 driven by the digital driving technique, the first edge detection block 250 may generate the first detection signal FDS indicating whether the logic level LGC(1) of the first adjacent data signal DIG(1) is changed. For this operation, the first edge detection block 250 may include a rising edge detector 210-1 that detects a rising edge of the first input signal CLD(1) and a falling edge detector 220-1 that detects a falling edge of the first input signal CLD(1). The first detection signal FDS may indicate whether the first input signal CLD(1) is changed. In other words, the first detection signal FDS may indicate whether the first input signal CLD(1) includes the rising edge or the falling edge.

For example, when an output signal output from the rising edge detector 210-1 has a first logic level (e.g., a logic ‘high’ level) and an output signal output from the falling edge detector 220-1 has a second logic level (e.g., a logic ‘low’ level), the first detection signal FDS may indicate that the first input signal CLD(1) includes the rising edge. When the output signal output from the rising edge detector 210-1 has a second logic level (e.g., a logic ‘low’ level) and the output signal output from the falling edge detector 220-1 has a first logic level (e.g., a logic ‘high’ level), the first detection signal FDS may indicate that the first input signal CLD(1) includes the falling edge. On the other hand, when the output signal output from the rising edge detector 210-1 has a second logic level (e.g., a logic ‘low’ level) and the output signal output from the falling edge detector 220-1 has the second logic level (e.g., a logic ‘low’ level), the first detection signal FDS may indicate that the first input signal CLD(1) is not changed.

The second edge detection block 260 generates a second detection signal SDS indicating whether the second input signal CLD(2) is changed. For example, in the display device 100 driven by the analog driving technique, the second edge detection block 260 may generate the second detection signal SDS indicating whether the most significant bit MSB(2) of the second adjacent data signal DIG(2) is changed.

In addition, in the display device 100 driven by the digital driving technique, the second edge detection block 260 may generate the second detection signal SDS indicating whether the logic level LGC(2) of the second adjacent data signal DIG(2) is changed. For this operation, the second edge detection block 260 may include a rising edge detector 210-2 that detects a rising edge of the second input signal CLD(2) and a falling edge detector 220-2 that detects a falling edge of the second input signal CLD(2). The second detection signal SDS may indicate whether the second input signal CLD(2) is changed. In other words, the second detection signal SDS may indicate whether the second input signal CLD(2) includes the rising edge or the falling edge.

For example, when an output signal output from the rising edge detector 210-2 has a first logic level (e.g., a logic ‘high’ level) and an output signal output from the falling edge detector 220-2 has a second logic level (e.g., a logic ‘low’ level), the second detection signal SDS may indicate that the second input signal CLD(2) includes the rising edge. When the output signal output from the rising edge detector 210-2 has a second logic level (e.g., a logic ‘low’ level) and the output signal output from the falling edge detector 220-2 has a first logic level (e.g., a logic ‘high’ level), the second detection signal SDS may indicate that the second input signal CLD(2) includes the falling edge. On the other hand, when the output signal output from the rising edge detector 210-2 has a second logic level (e.g., a logic ‘low’ level) and the output signal output from the falling edge detector 220-2 has the second logic level (e.g., a logic ‘low’ level), the second detection signal SDS may indicate that the second input signal CLD(2) is not changed.

The edge comparison block 270 may output a comparison result signal CRS, which indicates whether the first input signal CLD(1) and the second input signal CLD(2) have different logic levels, based on the first detection signal FDS and the second detection signal SDS. For example, the edge comparison block 270 may output the comparison result signal CRS, which indicates whether the most significant bit MSB(1) of the first adjacent data signal DIG(1) and the most significant bit MSB(2) of the second adjacent data signal DIG(2) have different logic levels, based on the first detection signal FDS and the second detection signal SDS in the display device 100 driven by the analog driving technique.

In addition, the edge comparison block 270 may output the comparison result signal CRS, which indicates whether the logic level LGC(1) of the first adjacent data signal DIG(1) and the logic level LGC(2) of the second adjacent data signal DIG(2) are different, based on the first detection signal FDS and the second detection signal SDS in the display device 100 driven by the digital driving technique.

For this operation, the edge comparison block 270 may include a first edge comparator 230-1 and a second edge comparator 230-2. The first edge comparator 230-1 may compare an output of the rising edge detector 210-1 in the first edge detection block 250 with an output of the falling edge detector 220-2 in the second edge detection block 260. The second edge comparator 230-2 may compare an output of the falling edge detector 220-1 in the first edge detection block 250 with an output of the rising edge detector 210-2 in the second edge detection block 260.

For example, the first edge comparator 230-1 may output an output signal having a first logic level (e.g., a logic ‘high’ level) only when the first input signal CLD(1) includes the rising edge and the second input signal CLD(2) includes the falling edge. In other cases, the first edge comparator 230-1 may output an output signal having a second logic level (e.g., a logic ‘low’ level). The second edge comparator 230-2 may output an output signal having a first logic level (e.g., a logic ‘high’ level) only when the first input signal CLD(1) includes the falling edge and the second input signal CLD(2) includes the rising edge. In other cases, the second edge comparator 230-2 may output an output signal having a second logic level (e.g., a logic ‘low’ level).

Thus, the comparison result signal CRS may indicate whether the first and second input signals CLD(1) and CLD(2) have different logic levels based on the output signal of the first edge comparator 230-1 and the output signal of the second edge comparator 230-2. The edge comparison block 270 may be reset based on the charge-sharing reset signal RESET at a predetermined time.

The signal generation block 280 generates the charge-sharing control signal CS based on the comparison result CRS output from the edge comparison block 270. As described above, the charge-sharing control block 200 may turn on the charge-sharing control switch in the display panel 110 by outputting the charge-sharing control signal CS having a first logic level (e.g., a logic ‘high’ level) when the first and second input signals CLD(1) and CLD(2) are changed and the first and second input signals CLD(1) and CLD(2) have different logic levels. Thus, the charge-sharing may be performed between the adjacent data lines in the charge-sharing period.

On the other hand, the charge-sharing control block 200 may turn off the charge-sharing control switch in the display panel 110 by outputting the charge-sharing control signal CS having a second logic level (e.g., a logic ‘low’ level) when at least one of the first input signal CLD(1) or the second input signal CLD(2) is not changed and/or the first and second input signals CLD(1) and CLD(2) have the same logic levels. Thus, the charge-sharing may not be performed between adjacent data lines in the charge-sharing period.

For this operation, the signal generation block 280 may include a first logical AND element 240-1, a second logical AND element 240-2, and a logical OR element 245. The first logical AND element 240-1 may perform a logical AND operation between the output signal of the first edge comparator 230-1 and the charge-sharing enable signal CS-ENABLE. The second logical AND element 240-2 may perform a logical AND operation between the output signal of the second edge comparator 230-2 and the charge-sharing enable signal CS-ENABLE. The logical OR element 245 may perform a logical OR operation between the output signal of the first logical AND element 240-1 and the output signal of the second logical AND element 240-2.

As a result, the signal generation block 280 may output the charge-sharing control signal CS having a first logic level (e.g., a logic ‘high’ level) when the first input signal CLD(1) includes the falling edge and the second input signal CLD(2) includes the rising edge or when the first input signal CLD(1) includes the rising edge and the second input signal CLD(2) includes the falling edge. In other cases, the signal generation block 280 may output the charge-sharing control signal CS having a second logic level (e.g., a logic ‘low’ level).

In one embodiment, an operation of the signal generation block 280 that selectively outputs the charge-sharing control signal CS having a first logic level (e.g., a logic ‘high’ level) or the charge-sharing control signal CS having a second logic level (e.g., a logic ‘low’ level) may be performed only while the charge-sharing enable signal CS-ENABLE is activated (e.g., in the charge-sharing period). For example, only while the charge-sharing enable signal CS-ENABLE is activated, the signal generation block 280 may output the charge-sharing control signal CS having a first logic level (e.g., a logic ‘high’ level) when the first input signal CLD(1) includes the falling edge and the second input signal CLD(2) includes the rising edge or when the first input signal CLD(1) includes the rising edge and the second input signal CLD(2) includes the falling edge. In other cases, the signal generation block 280 may output the charge-sharing control signal CS having a second logic level (e.g., a logic ‘low’ level).

On the other hand, while the charge-sharing enable signal CS-ENABLE is deactivated (e.g., in the pixel operation period), the signal generation block 280 may output only the charge-sharing control signal CS having a second logic level (e.g., a logic ‘low’ level) regardless of the first and second input signals CLD(1) and CLD(2). For example, while the charge-sharing enable signal CS-ENABLE is deactivated, the signal generation block 280 may turn off the charge-sharing control switch in the display panel 110 by outputting only the charge-sharing control signal CS having a second logic level (e.g., a logic ‘low’ level). Thus, the charge-sharing may not be performed between adjacent data lines in the pixel operation period.

The charge-sharing control block 200 in FIG. 5 is illustrative of only one embodiment. In another embodiment, the charge-sharing control block 200 may have a different structure.

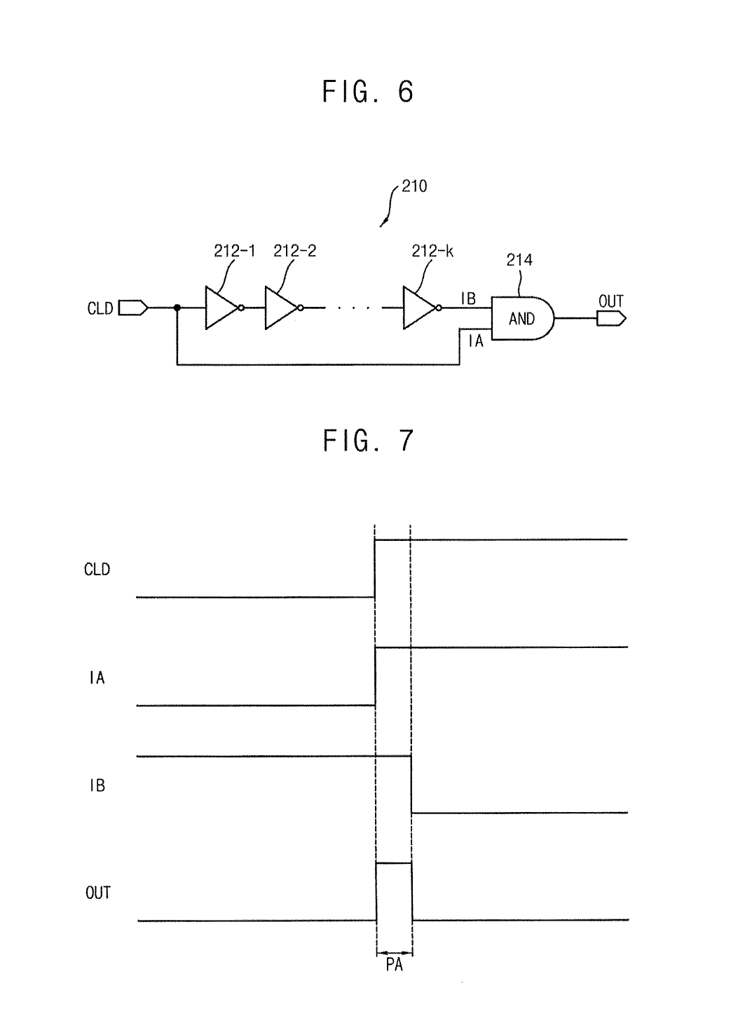

FIG. 6 illustrates an embodiment of a rising edge detector that may be included, for example, in each of first and second edge detection blocks in the charge-sharing control block of FIG. 5. FIG. 7 is a timing diagram illustrating an example of control signals for the rising edge detector 210 of FIG. 6.

Referring to FIGS. 6 and 7, the rising edge detector 210 includes first through (k)th inverters 212-1 through 212-k (where k is an odd number greater than or equal to 1) and a logical AND element 214. In operation, the rising edge detector 210 receives an input signal CLD corresponding to one or more predetermined bits (e.g., the most significant bit) of the data signal in the display device 100 driven by the analog driving technique and corresponding to the logic level of the data signal in the display device 100 driven by the digital driving technique.

As illustrated in FIG. 7, when the logic level of the input signal CLD rises from a logic ‘low’ level to a logic ‘high’ level (e.g., a rising edge), the logic level of a first signal IA applied to a first terminal of the logical AND element 214 may also rise from a logic ‘low’ level to a logic ‘high’ level (e.g., a rising edge). When the logic level of the input signal CLD rises from a logic ‘low’ level to a logic ‘high’ level (e.g., the rising edge), a logic level of a second signal IB, which is generated in a way that the input signal CLD passes through the first through (k)th inverters 212-1 through 212-k, may also fall from a logic ‘high’ level to a logic ‘low’ level (e.g., a falling edge).

Since the second signal IB is generated in a way that the input signal CLD passes through the first through (k)th inverters 212-1 through 212-k, a time difference PA may exist between the rising edge of the first signal IA and the falling edge of the second signal IB. Thus, when the logical AND element 214 performs a logical AND operation between the first signal IA and the second signal IB, an output signal OUT having a logic ‘high’ level during a period corresponding to the time difference PA may be generated.

As a result, when the input signal CLD (e.g., the most significant bit of the data signal in the display device 100 driven by the analog driving technique or the logic level of the data signal in the display device 100 driven by the digital driving technique) includes the rising edge, the rising edge detector 210 may generate the output signal OUT having a logic ‘high’ level during the period corresponding to the time difference PA to indicate that the input signal CLD includes the rising edge. On the other hand, when the input signal CLD does not include the rising edge, the rising edge detector 210 may generate the output signal OUT having a logic ‘low’ level to indicate that the input signal CLD does not include the rising edge. The rising edge detector 210 may have a different embodiment in another embodiment.

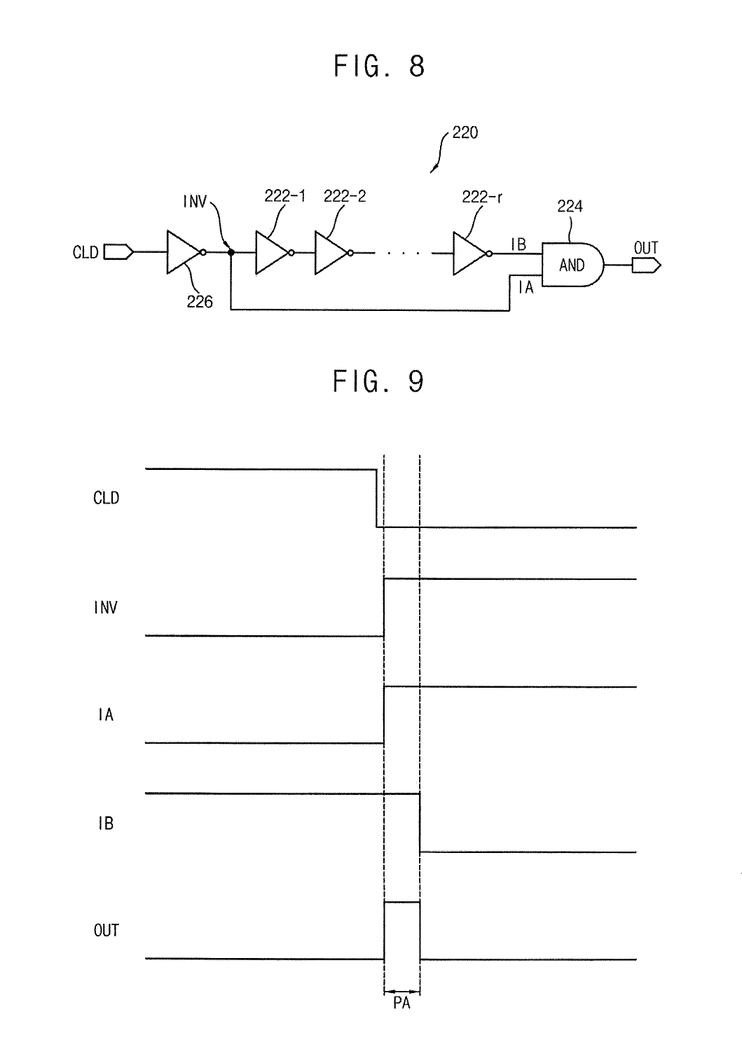

FIG. 8 illustrates an example of a falling edge detector 220 that may be included, for example, in each of first and second edge detection blocks of the charge-sharing control block of FIG. 5. FIG. 9 is an example of a timing diagram of control signals for the falling edge detector 220 of FIG. 8. Referring to FIGS. 8 and 9, the falling edge detector 220 includes an inverter 226, first through (r)th inverters 222-1 through 222-r (where r is an odd number greater than or equal to 1) and a logical AND element 224. The falling edge detector may have a different structure in another embodiment.

In this embodiment, the falling edge detector 220 receives an input signal CLD corresponding to one or more predetermined bits (e.g., most significant bit) of the data signal in display device 100 driven by the analog driving technique and corresponding to the logic level of the data signal in the display device 100 driven by the digital driving technique. As illustrated in FIG. 9, when a logic level of the input signal CLD falls from a logic ‘high’ level to a logic ‘low’ level (e.g., a falling edge), an inverted signal INV may be generated because the inverter 226 inverts the input signal CLD.

For example, when the logic level of the input signal CLD falls from a logic ‘high’ level to a logic ‘low’ level (e.g., the falling edge), a logic level of the inverted signal INV may rise from a logic ‘low’ level to a logic ‘high’ level (e.g., a rising edge). Here, a time difference may exist between the falling edge of the input signal CLD and the rising edge of the inverted signal INV.

When the logic level of the inverted signal INV rises from a logic ‘low’ level to a logic ‘high’ level (e.g., the rising edge), a first signal IA applied to a first terminal of the logical AND element 224 may rise from a logic ‘low’ level to a logic ‘high’ level (e.g., a rising edge). When the logic level of the inverted signal INV rises from a logic ‘low’ level to a logic ‘high’ level (e.g., the rising edge), a logic level of a second signal IB, which is generated in a way that the inverted signal INV passes through the first through (r)th inverters 222-1 through 222-r, may fall from a logic ‘high’ level to a logic ‘low’ level (i.e., a falling edge). Here, since the second signal IB is generated in a way that the inverted signal INV passes through the first through (r)th inverters 222-1 through 222-r, a time difference PA may exist between the rising edge of the first signal IA and the falling edge of the second signal IB.

Thus, when the logical AND element 224 performs a logical AND operation between the first signal IA and the second signal IB, an output signal OUT having a logic ‘high’ level during a period corresponding to the time difference PA may be generated. As a result, when the input signal CLD (e.g., the most significant bit of the data signal in the display device 100 driven by the analog driving technique or the logic level of the data signal in the display device 100 driven by the digital driving technique) includes the falling edge, the falling edge detector 220 may generate the output signal OUT having a logic ‘high’ level during the period corresponding to the time difference PA to indicate that the input signal CLD includes the falling edge. On the other hand, when the input signal CLD does not include the falling edge, the falling edge detector 220 may generate the output signal OUT having a logic ‘low’ level to indicate that the input signal CLD does not include the falling edge.

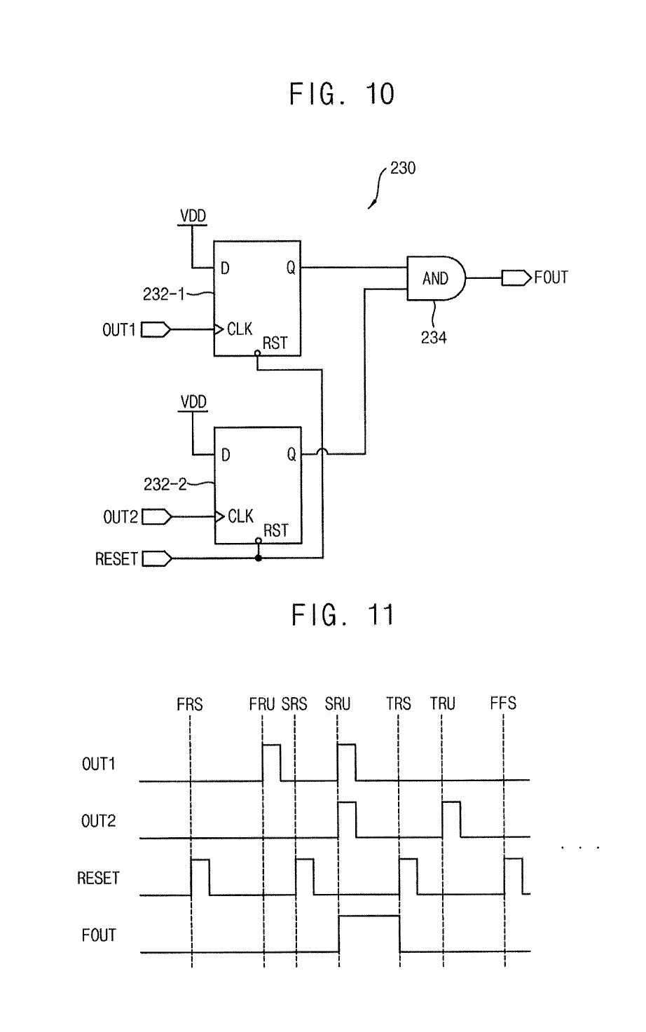

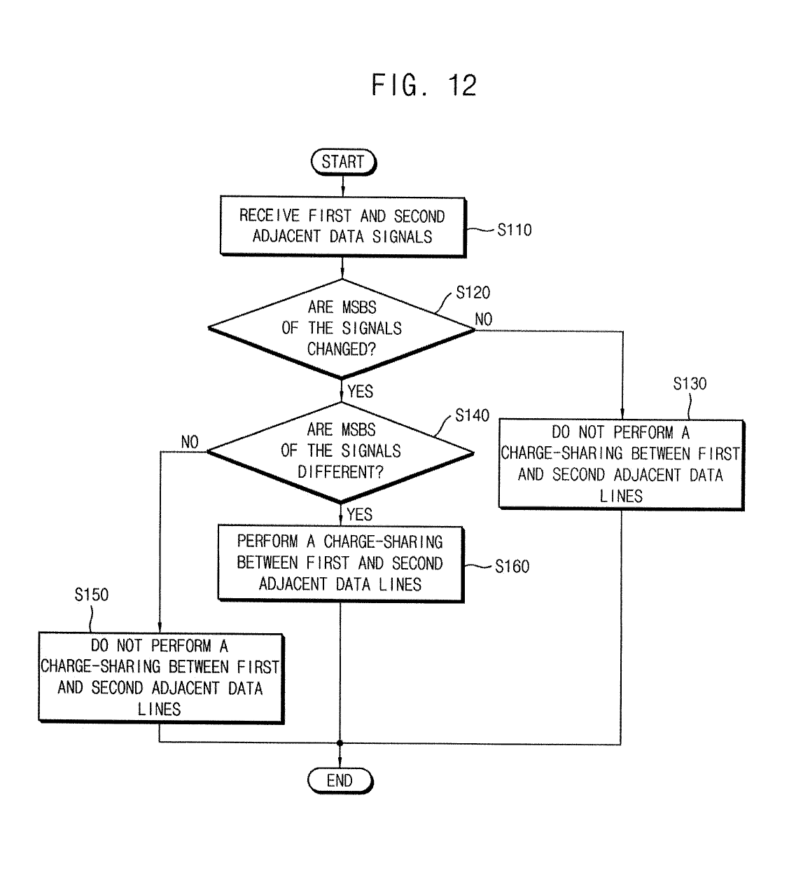

FIG. 10 illustrates an embodiment of an edge comparator 230 that may be included, for example, in an edge comparison block in the charge-sharing control block of FIG. 5. FIG. 11 illustrates an example of a timing diagram of control signals for the edge comparator of FIG. 10.

Referring to FIGS. 10 and 11, the edge comparator 230 in the edge comparison block 270 includes a first D-flip-flop 232-1, a second D-flip-flop 232-2, and a logical AND element 234. The edge comparator may have a different structure in another embodiment.

In this embodiment, the edge comparison block 270 outputs the comparison result signal CRS indicating whether the first and second input signals CLD(1) and CLD(2) have different logic levels based on the first detection signal FDS indicating whether the first input signal CLD(1) is changed and the second detection signal SDS indicating whether the second input signal CLD(2) is changed. For example, based on the first detection signal FDS and the second detection signal SDS, the edge comparison block 270 may output the comparison result signal CRS indicating whether one or more predetermined bits (e.g., the most significant bit) of the first and second adjacent data signals have different logic levels in the display device 100 driven by the analog driving technique, and may output the comparison result signal CRS indicating whether the logic levels of the first and second adjacent data signals are different in the display device 100 driven by the digital driving technique.

For this operation, the edge comparator 230 in the edge comparison block 270 includes a first edge comparator 230-1 and a second edge comparator 230-2. The first edge comparator 230-1 may receive an output signal OUT1 from a rising edge detector 210-1 of a first edge detection block 250 and an output signal OUT2 from a falling edge detector 220-2 of a second edge detection block 260. The second edge comparator 230-2 may receive an output signal OUT1 from a rising edge detector 210-2 of a second edge detection block 260 and an output signal OUT2 from a falling edge detector 220-1 of a first edge detection block 250. For convenience of description, the edge comparator 230 will be described as the first edge comparator 230-1 that receives the output signal OUT1 output from the rising edge detector 210-1 of the first edge detection block 250 and the output signal OUT2 output from the falling edge detection 220-2 of the second edge detection block 260.

The first D-flip-flop 232-1 may output a power voltage VDD applied to an input terminal D via an output terminal Q based on the output signal OUT1 applied to a clock terminal CLK. The first D-flip-flop 232-1 may be reset (or initialized) based on a reset signal RESET applied to a reset terminal RST. Thus, the first D-flip-flop 232-1 may output the power voltage VDD via the output terminal Q when a logic level of the output signal OUT1 applied to the clock terminal CLK is changed from a logic ‘low’ level to a logic ‘high’ level.

Similarly, the second D-flip-flop 232-2 may output the power voltage VDD applied to an input terminal D via an output terminal Q based on the output signal OUT2 applied to a clock terminal CLK. The second D-flip-flop 232-2 may be reset (or initialized) based on the reset signal RESET applied to a reset terminal RST. Thus, the second D-flip-flop 232-2 may output the power voltage VDD via the output terminal Q when a logic level of the output signal OUT2 applied to the clock terminal CLK is changed from a logic ‘low’ level to a logic ‘high’ level.

The logical AND element 234 may perform a logical AND operation between an output signal of the first D-flip-flop 232-1 and an output signal of the second D-flip-flop 232-2. Here, since the output signal OUT1 applied to the first D-flip-flop 232-1 is output from the rising edge detector 210-1 of the first edge detection block 250, a change of the logic level of the output signal OUT1 applied to the clock terminal CLK of the first D-flip-flop 232-1 from a logic ‘low’ level to a logic ‘high’ level may indicate that the first input signal CLD(1) includes the rising edge.

In addition, since the output signal OUT2 applied to the second D-flip-flop 232-2 is output from the falling edge detector 220-2 of the second edge detection block 260, a change of the logic level of the output signal OUT2 applied to the clock terminal CLK of the second D-flip-flop 232-2 from a logic ‘low’ level to a logic ‘high’ level may indicate that the second input signal CLD(2) includes the falling edge. Therefore, when the output signal FOUT from the logical AND element 234 has a logic ‘high’ level, this may indicate that the first and second input signals CLD(1) and CLD(2) have different logic levels. For example, as illustrated in FIG. 11, the first and second D-flip-flops 232-1 and 232-2 may be reset (e.g., indicated as FRS) as the reset signal RESET is activated.

Subsequently, the logic level of the output signal OUT1 applied to the first D-flip-flop 232-1 is changed from a logic ‘low’ level to a logic ‘high’ level, but the logic level of the output signal OUT2 applied to the second D-flip-flop 232-2 may not be changed from a logic ‘low’ level to a logic ‘high’ level (e.g., indicated as FRU). Thus, the output signal FOUT from the logical AND element 234 may be maintained to have a logic ‘low’ level. For example, the output signal FOUT output from the logical AND element 234 may indicate that the first input signal CLD(1) includes the rising edge and the second input signal CLD(2) does not include the falling edge.

Next, the first and second D-flip-flops 232-1 and 232-2 may be reset (i.e., indicated as SRS) as the reset signal RESET is activated.

Subsequently, the logic level of the output signal OUT1 applied to the first D-flip-flop 232-1 is changed from a logic ‘low’ level to a logic ‘high’ level, and the logic level of the output signal OUT2 applied to the second D-flip-flop 232-2 may be changed from a logic ‘low’ level to a logic ‘high’ level (e.g., indicated as SRU). Thus, a logic level of the output signal FOUT from the logical AND element 234 may be changed from a logic ‘low’ level to a logic ‘high’ level. For example, the output signal FOUT output from the logical AND element 234 may indicate that the first input signal CLD(1) includes the rising edge and the second input signal CLD(2) includes the falling edge.

Next, the first and second D-flip-flops 232-1 and 232-2 may be reset (e.g., indicated as TRS) as the reset signal RESET is activated.

Subsequently, the logic level of the output signal OUT2 applied to the second D-flip-flop 232-2 is changed from a logic ‘low’ level to a logic ‘high’ level, but the logic level of the output signal OUT1 applied to the first D-flip-flop 232-1 may not be changed from a logic ‘low’ level to a logic ‘high’ level (e.g., indicated as TRU). Thus, the output signal FOUT output from the logical AND element 234 may be maintained to have a logic ‘low’ level. For example, the output signal FOUT output from the logical AND element 234 may indicate that the second input signal CLD(2) includes the falling edge and the first input signal CLD(1) does not include the rising edge.

Next, the first and second D-flip-flops 232-1 and 232-2 may be reset (i.e., indicated as FFS) as the reset signal RESET is activated.

In this way, the edge comparator 230 may output the output signal FOUT including information related to the first and second input signals CLD(1) and CLD(2) based on the output signal OUT1 applied to the first D-flip-flop 232-1 and the output signal OUT2 applied to the second D-flip-flop 232-2.

FIG. 12 illustrates an embodiment of a method for performing charge-sharing for a display device. The method may be applied to a display device, for example driven by an analog driving technique. In this case, adjacent data voltages generated by performing a digital-analog conversion on adjacent data signals may be grayscale representation voltages for pixels in a display panel, and the adjacent data signals may be digital signals indicating grayscale values to be represented by the pixels in the display panel. For example, each of the adjacent data signals may include a plurality of bits to indicate the grayscale values to be represented by the pixels in the display panel.

Referring to FIG. 12, the method includes receiving a first adjacent data signal and a second adjacent data signal (S110) and checking whether one or more predetermined bits (e.g., the most significant bit) of the first adjacent data signal and the most significant bit of the second adjacent data signal are changed (S120). When at least one of the most significant bit of the first adjacent data signal or the most significant bit of the second adjacent data signal is not changed, the method of FIG. 12 may not perform charge-sharing between a first adjacent data line and a second adjacent data line (S130).

When the most significant bit of the first adjacent data signal is changed and the most significant bit of the second adjacent data signal is changed, the method includes checking whether the most significant bits of the first and second adjacent data signals are different (S140). When the most significant bits of the first and second adjacent data signals are the same (not different), charge-sharing may not be performed between the first adjacent data line and the second adjacent data line (S150). When the most significant bits of the first and second adjacent data signals are different, charge-sharing may be performed between the first adjacent data line and the second adjacent data line (S160).

As described above, the method may be implemented to determine whether to perform charge-sharing between adjacent data lines based on the most significant bits of adjacent data signals corresponding to adjacent data voltages to be applied to the adjacent data lines in the display device, for example, when driven by the analog driving technique. As a result, the method may independently perform charge-sharing only between the data lines that require the charge-sharing in the display device, for example driven by the analog driving technique.

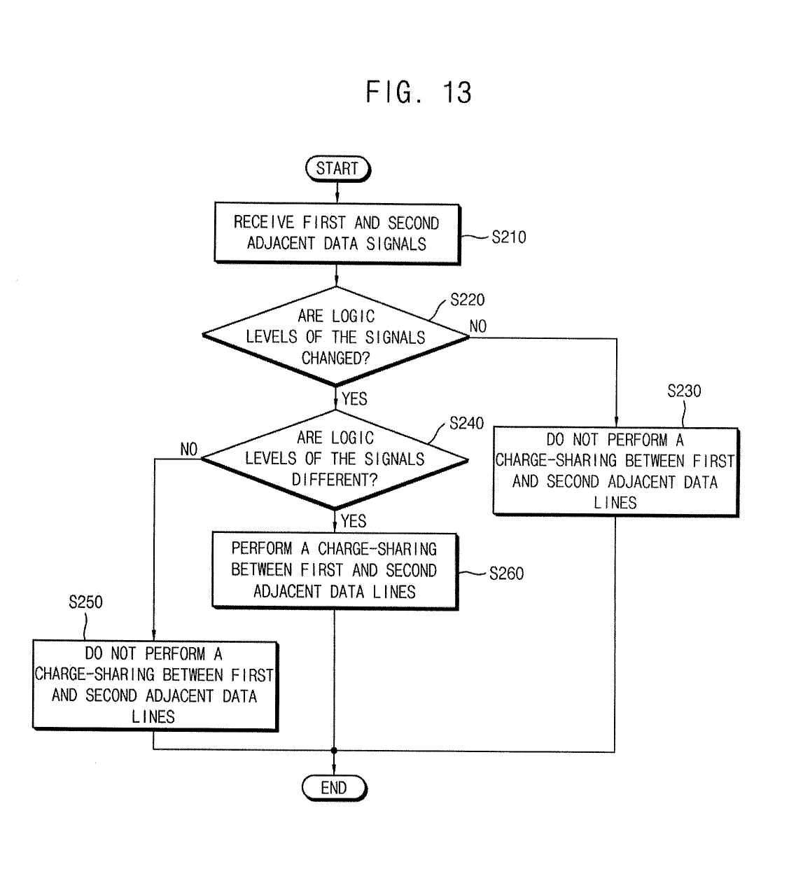

FIG. 13 illustrates another embodiment of a method for performing a charge-sharing for a display device. This method may be applied to a display device which, for example, is driven by a digital driving technique. In this case, adjacent data voltages generated by performing a digital-analog conversion on adjacent data signals may be driving transistor control voltages for pixels in a display panel. The adjacent data signals may be digital signals indicating a logic ‘high’ level or a logic ‘low’ level (e.g., for turning on or turning off the driving transistors of the pixels in the display panel). For example, each of the adjacent data signals may include (or correspond to) a single bit indicating a logic ‘high level or a logic ‘low’ level.

Referring to FIG. 13, the method includes receiving a first adjacent data signal and a second adjacent data signal (S210) and checking whether a logic level of the first adjacent data signal and a logic level of the second adjacent data signal are changed (S220). When at least one of the logic level of the first adjacent data signal or the logic level of the second adjacent data signal is not changed, charge-sharing may not be performed between a first adjacent data line and a second adjacent data line (S230).

On the other hand, when the logic level of the first adjacent data signal is changed and the logic level of the second adjacent data signal is changed, the method may include checking whether the logic levels of the first and second adjacent data signals are different (S240). When the logic levels of the first and second adjacent data signals are the same (not different), charge-sharing may not be performed between the first adjacent data line and the second adjacent data line (S250). On the other hand, when the logic levels of the first and second adjacent data signals are different, charge-sharing may be performed between the first adjacent data line and the second adjacent data line (S260).

As described above, the method of FIG. 13 may determine whether to perform charge-sharing between adjacent data lines based on the logic levels of adjacent data signals corresponding to adjacent data voltages to be applied to the adjacent data lines in the display device, for example, when driven by the digital driving technique. As a result, the method of FIG. 13 may independently perform charge-sharing only between the data lines that require charge-sharing in the display device, for example, when driven by the digital driving technique.

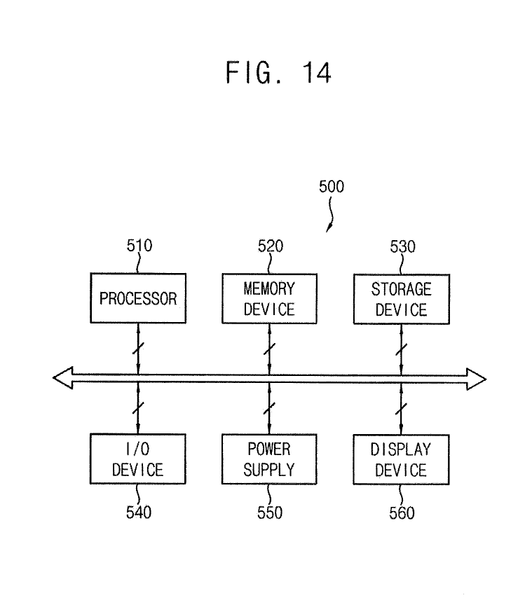

FIG. 14 illustrates an embodiment of an electronic device 500 that includes a display device. Referring to FIG. 14, the electronic device 500 includes a processor 510, a memory device 520, a storage device 530, an input/output (I/O) device 540, a power supply 550, and a display device 560. The display device 560 may correspond, for example, to the display device 100 of FIG. 1.

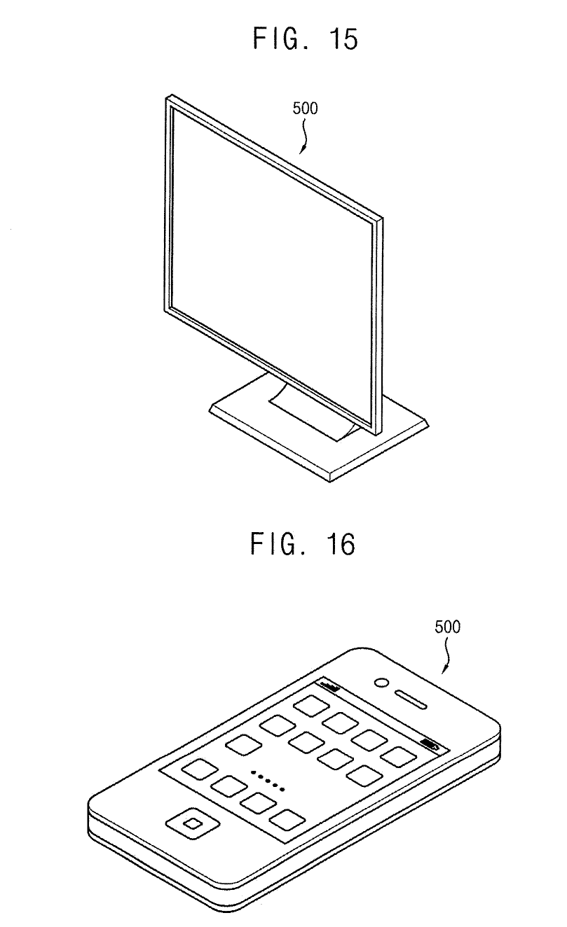

In addition, the electronic device 500 may include a plurality of ports for communicating with a video card, a sound card, a memory card, a universal serial bus (USB) device, other electronic devices, etc. As illustrated in FIG. 15, the electronic device 500 may be implemented as a television. As illustrated in FIG. 16, the electronic device 500 may be implemented as a smart phone. The electronic device may be a different device in another embodiment. Examples include a computer monitor, a laptop, a digital camera, a cellular phone, a video phone, a smart pad, a tablet PC, and a navigation system.

The processor 510 may perform various computing functions. The processor 510 may be a micro processor, a central processing unit (CPU), an application processor (AP), and/or another control or processing device. The processor 510 may be coupled to other components via an address bus, a control bus, a data bus, and/or various signal lines. Furthermore, the processor 510 may be coupled to an extended bus such as a peripheral component interconnection (PCI) bus.

The memory device 520 may store data for operations of the electronic device 500. For example, the memory device 520 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device such as a dynamic random access memory (DRAM) device, a static random access memory (SRAM) device, a mobile DRAM device, etc. The storage device 530 may include a solid state drive (SSD) device, a hard disk drive (HDD) device, a CD-ROM device, etc.

The I/O device 540 may include an input device such as a keyboard, a keypad, a mouse device, a touchpad, a touch-screen, etc., and an output device such as a printer, a speaker, etc. In one example embodiment, the display device 560 may be in the I/O device 540. The power supply 550 may provide power for operations of the electronic device 500. The display device 560 may be coupled to other components via the buses or other communication links.

The display device 560 may include a display panel, a scan driver, a data driver, and a timing controller. The display device 560 may be, for example, a liquid crystal display (LCD) device, an organic light emitting display (OLED) device, or another type of display device.

In an example embodiment, the display device 560 may be driven by an analog driving technique. Here, the display device 560 may include a charge-sharing control switch in the display panel and a charge-sharing control block to control the charge-sharing control switch in the data driver and to determine whether to perform charge-sharing between adjacent data lines based on one or more predetermined (e.g., most significant bits) of adjacent data signals corresponding to adjacent data voltages to be applied to the adjacent data lines.

In another example embodiment, the display device 560 may be driven by a digital driving technique. Here, the display device 560 may include the charge-sharing control switch in the display panel and the charge-sharing control block in the data driver. The charge-sharing control block may determine whether to perform charge-sharing between adjacent data lines based on logic levels of adjacent data signals corresponding to adjacent data voltages to be applied to the adjacent data lines.

As a result, the display device 560 may independently perform a charge-sharing only between data lines that require charge-sharing and may prevent a charge-sharing effect from being degraded by electrical resistive elements such as ESD resistance, bonding resistance, wiring resistance that exist in the data lines.

The present inventive concept may be applied to any electronic device that includes a display device. For example, the present inventive concept may be applied to a television, a computer monitor, a head mounted display (HMD) device, a laptop, a digital camera, a cellular phone, a smart phone, a smart pad, a tablet PC, a personal digital assistants (PDA), a portable multimedia player (PMP), an MP3 player, a car navigation system, a video phone, etc.

By way of summation and review, as size and speed increase, data lines for a display device may be insufficiently charged and discharged. In an attempt to prevent this from happening, a charge-sharing operation has been proposed for the data lines. The charge-sharing operation is performed by connecting all data lines in the display device, i.e., all output channels of a data driver. As a result, power consumption increases in data lines carrying data voltages that do not change, even though power consumption decreases in data lines carrying data voltages that do change.

The charge-sharing operation may also cause a number of other inconsistencies. For example, the data voltages are generated by converting digital signals from a timing controller to analog signals, and a charge-sharing control switch is located in the data driver. Consequently. the charge-sharing effect may be degraded by resistive elements (e.g., electrostatic discharge (ESD)) resistance, bonding resistance, and wiring resistance in the data lines that occur when charge-sharing is performed.

In accordance with one or more of the aforementioned embodiments, a display device includes a charge-sharing control switch in a display panel and a charge-sharing control block. Whether to perform charge-sharing between adjacent data-lines is determined based on one or more predetermined bits and/or logic levels of adjacent data signals corresponding to adjacent data voltages to be applied to the adjacent data lines. Thus, the display device may independently perform charge-sharing only between data lines that require charge-sharing and may prevent a charge-sharing effect from being degraded by electric resistive elements that exist in the data lines.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A display device, comprising:
a display panel including pixels and charge-sharing control switches, the pixels connected to scan lines and data lines and each of the charge-sharing control switches connected between adjacent data lines;
a scan driver to provide sequentially activated scan signals via the scan lines;
a data driver to provide data voltages generated by performing a digital-to-analog conversion on data signals provided via the data lines and to control the charge-sharing control switches based on one or more predetermined bits of adjacent data signals corresponding to adjacent data voltages to be applied to the adjacent data lines, the data driver to control the charge-sharing control switches in a charge-sharing period; and
a timing controller to control the scan driver and the data driver and to provide the data signals to the data driver.

2. The display device as claimed in claim 1, wherein:
the data voltages are grayscale representation voltages for the pixels,
the data signals are digital signals indicating grayscale values for the pixels, and the display device is to be driven by an analog driving technique.

3. The display device as claimed in claim 2, wherein:
the data driver includes a plurality of charge-sharing control blocks, and
each of the charge-sharing control blocks connected between the adjacent data lines and to generate a charge-sharing control signal based on the one or more predetermined bits of the adjacent data signals, the charge-sharing control signal to determine whether to turn on or turn off a corresponding one of the charge-sharing control switches.

4. The display device as claimed in claim 3, wherein:
the charge-sharing control signal has a first voltage level for turning on the corresponding one of the charge-sharing control switches or a second voltage level for turning off the corresponding one of the charge-sharing control switches when a charge-sharing enable signal is activated, and
the charge-sharing control signal only has the second voltage level for turning off the corresponding one of the charge-sharing control switches when the charge-sharing enable signal is deactivated.

5. The display device as claimed in claim 3, wherein:
the adjacent data lines include a first adjacent data line and a second adjacent data line,
the adjacent data signals include a first adjacent data signal applied to the first adjacent data line and a second adjacent data signal applied to the second adjacent data line, and
the corresponding one of the charge-sharing control switches includes a transistor having a first electrode connected to the first adjacent data line, a second electrode connected to the second adjacent data line, and a gate electrode that receives the charge-sharing control signal.

6. The display device as claimed in claim 5, wherein each of the charge-sharing control blocks includes:
a first edge detection block to generate a first detection signal indicating whether the one or more predetermined bits of the first adjacent data signal is changed;
a second edge detection block to generate a second detection signal indicating whether the one or more predetermined bits of the second adjacent data signal is changed;
an edge comparison block to output a comparison result signal indicating whether the one or more predetermined bits of the first and second adjacent data signals have different logic levels based on the first detection signal and the second detection signal; and
a signal generation block to generate the charge-sharing control signal based on the comparison result signal.

7. The display device as claimed in claim 5, wherein charge-sharing is performed between the first adjacent data line and the second adjacent data line as the first adjacent data line is electrically connected to the second adjacent data line, when the corresponding one of the charge-sharing control switches is turned on based on the charge-sharing control signal in the charge-sharing period.

8. The display device as claimed in claim 7, wherein each of the charge-sharing control blocks is to turn-on the corresponding one of the charge-sharing control switches in the charge-sharing period when:
the one or more predetermined bits of the first adjacent data signal is changed,
the one or more predetermined bits of the second adjacent data signal is changed, and
the one or more predetermined bits of the first and second adjacent data signals have different logic levels.

9. The display device as claimed in claim 5, wherein charge-sharing is not performed between the first adjacent data line and the second adjacent data line as the first adjacent data line is electrically separated from the second adjacent data line when the corresponding one of the charge-sharing control switches is turned off based on the charge-sharing control signal in the charge-sharing period.

10. The display device as claimed in claim 9, wherein each of the charge-sharing control blocks is to turn-off the corresponding one of the charge-sharing control switches in the charge-sharing period when:
the one or more predetermined bits of the first adjacent data signal is not changed,
the one or more predetermined bits of the second adjacent data signal is not changed, or
the one or more predetermined bits of the first and second adjacent data signals have same logic levels.

11. The display device as claimed in claim 1, wherein the one or more predetermined bits includes a most significant bit.

12. A display device, comprising:
a display panel including pixels and charge-sharing control switches, the pixels connected to scan lines and data lines and each of the charge-sharing control switches connected between adjacent data lines;
a scan driver to provide sequentially activated scan signals via the scan lines;
a data driver to provide data voltages generated by performing a digital-to-analog conversion on data signals provided via the data lines and to control the charge-sharing control switches based on logic levels of adjacent data signals corresponding to adjacent data voltages to be applied to the adjacent data lines, the data driver to control the charge-sharing control switches in a charge-sharing period; and
a timing controller to control the scan driver and the data driver and to provide the data signals to the data driver.

13. The display device as claimed in claim 12, wherein:
the data voltages are driving transistor control voltages for the pixels,
the data signals are digital signals indicating a logic high level or a logic low level, and the display device is to be driven by a digital driving technique.

14. The display device as claimed in claim 13, wherein:
the data driver includes a plurality of charge-sharing control blocks, and
each of the charge-sharing blocks connected between the adjacent data lines and to generate a charge-sharing control signal based on the logic levels of the adjacent data signals, the charge-sharing control signal indicating whether to turn on or turn off a corresponding one of the charge-sharing control switches.

15. The display device as claimed in claim 14, wherein:
the charge-sharing control signal has a first voltage level for turning on the corresponding one of the charge-sharing control switches or a second voltage level for turning off the corresponding one of the charge-sharing control switches when a charge-sharing enable signal is activated, and
the charge-sharing control signal only has the second voltage level for turning off the corresponding one of the charge-sharing control switches when the charge-sharing enable signal is deactivated.

16. The display device as claimed in claim 14, wherein:
the adjacent data lines include a first adjacent data line and a second adjacent data line,
the adjacent data signals include a first adjacent data signal applied to the first adjacent data line and a second adjacent data signal applied to the second adjacent data line, and
the corresponding one of the charge-sharing control switches includes a transistor having a first electrode connected to the first adjacent data line, a second electrode connected to the second adjacent data line, and a gate electrode to receive the charge-sharing control signal.

17. The display device as claimed in claim 16, wherein each of the charge-sharing control blocks includes:
a first edge detection block to generate a first detection signal indicating whether the logic level of the first adjacent data signal is changed;
a second edge detection block to generate a second detection signal indicating whether the logic level of the second adjacent data signal is changed;
an edge comparison block to output a comparison result signal indicating whether the logic levels of the first and second adjacent data signals are different based on the first detection signal and the second detection signal; and
a signal generation block to generate the charge-sharing control signal based on the comparison result signal.

18. The display device as claimed in claim 16, wherein charge-sharing is to be performed between the first adjacent data line and the second adjacent data line as the first adjacent data line is electrically connected to the second adjacent data line when the corresponding one of the charge-sharing control switches is turned on based on the charge-sharing control signal in the charge-sharing period.

19. The display device as claimed in claim 18, wherein each of the charge-sharing control blocks is to turn-on the corresponding one of the charge-sharing control switches in the charge-sharing period when the logic level of the first adjacent data signal is changed, the logic level of the second adjacent data signal is changed, and the logic levels of the first and second adjacent data signals are different.

20. The display device as claimed in claim 16, wherein charge-sharing is not to be performed between the first adjacent data line and the second adjacent data line as the first adjacent data line is electrically separated from the second adjacent data line, when the corresponding one of the charge-sharing control switches is turned off based on the charge-sharing control signal in the charge-sharing period, and
wherein each of the charge-sharing control blocks is to turn-off the corresponding one of the charge-sharing control switches in the charge-sharing period when:
the logic level of the first adjacent data signal is not changed,
the logic level of the second adjacent data signal is not changed, or
the logic levels of the first and second adjacent data signals are equal.
